(19) United States
(12) Patent Application Publication
(10) Pub. No.: US 2006/0184490 A1
(43) Pub. Date: Aug. 17, 2006

(54) System and method for enterprise policy management

(76) Inventors: Itamar Heim, Ramot-HaShavim (IL); Nadav Kenneth, Tel-Aviv (IL); Yuval Kashtan, Moshav Mishmeret (IL)

Correspondence Address: Martin D. Moynihan;PRTSI, Inc., P.O. Box 16446, Arlington, VA, 22215, US

(21) Appl. No.: 11/349,977

(22) Filed: Feb. 9, 2006

Related U.S. Application Data
(60) Provisional application No. 60/652,435, filed on Feb. 11, 2005.

(51) Int. Cl. G06N 5/02

(52) U.S. Cl. 706/46

(57) ABSTRACT

Apparatus for computer network management, comprising: a knowledge definer, operable for defining a knowledge module comprised of a plurality of knowledge items, hierarchically arranged according to technologies, each of the knowledge items comprising possible values for a configuration activity of one of the technologies. The apparatus further includes a policy definer, associated with the knowledge definer, operable for defining at least one technical policy based on the knowledge module, usable for overriding selected values of the possible values while keeping remaining values of the possible values, the technical policy inheriting from the knowledge module.

### RELATED APPLICATIONS

The present application claims priority from U.S. Provisional Patent Application No. 60/652,435, filed on Feb. 11, 2005, the contents of which are hereby incorporated by reference.

### FIELD AND BACKGROUND OF THE INVENTION

The present invention relates to configuration management in a computer network and, more particularly, but not exclusively to methods and an apparatus for computer network policy management.

Security Configuration Management (SCM)—how to manage the configurations of multiple devices in a computer network with regards to correcting known vulnerabilities, keeping a leased privileged configuration, making the most of existing security features in the product and maintaining this intended policy (a process also known as System Hardening) has become a major challenge for current businesses.

For example, according to the Computer Emergency Response Team Coordination Center (CERT®-CC), more than 95% of computer network intrusions are based on exploitation of known vulnerabilities or configuration errors where countermeasures are available.

A computer network generally includes a number of devices, such as switches, routers, servers, printers, and other devices. The devices are often categorized into two classes: end stations—such as work stations, desktop PCs, printers, servers, hosts, fax machines, and devices that primarily supply or consume information, and network devices—such as switches and routers that primarily forward information between the other devices.

System Administrators are the people who are in charge of interpreting an organization's security policy as it applies to the usage of each device on the network.

System Administrators are also responsible for writing and applying security policies in the computer network.

Security administrators need tools that help them formulate their site's security policies and translate the policies into monitoring and enforcement mechanisms

Currently, security policies are generally prepared using an ordered list of rules.

In traditional approaches, the network devices are designed to interact with operating systems having text-based, command-line interfaces.

Because of these interfaces, administrators have to learn the command sets that control how the devices operate. The command sets are cryptic and difficult to use. The command sets differ from one device vendor to the next.

Moreover, inter-relationships between different lines of a command set may cause problems. For example, a previous rule may affect the execution of all later rules, or even prevent their use.

The inter-relationships between different lines of commands are difficult to remember or track.

For example, a router is typically configured using a set of router rule commands that determine whether the router should forward or reject packets based upon a combination of inter-related commands relating to the type of packet, the originating network location, the destination location, etc.

The rule commands are typically input as textual lists of commands which very rapidly become complex, difficult to understand, and hard to maintain. Such textual lists of rule commands resemble computer programs written in a procedural programming language. The rule sets may be difficult to manage or decipher, regardless of the system administrator's level of expertise.

In another example, U.S. Pat. No. 5,835,726, to Shwed, entitled “System for securing the flow of and selectively modifying packets in a computer network”, filed on Jun. 17, 1996, discloses a Firewall system for controlling the inbound and outbound data packet flow in a private computer network. Firewalls rely on database tables that describe how to handle data packets arriving from particular locations or services. The Firewalls are configured by preparing a list of instructions derived from the rows, columns, and logical relationships of the tables. Generally, the table-based languages are arcane and hard to use.

That is to say, with the current methods the devices are configured by cryptic command lists requiring low-level knowledge about networks, network protocols, devices, operating systems, and the like. The system administrators have to program device-specific security policies that are complicated to create and cumbersome to maintain. In developing and deploying such security policies, administrators are required to engage in excessive and cumbersome device specific configurations. Typically the configurations are carried out using text-based, command-line interfaces.

The cumbersome policy configuration makes it difficult for administrators of complex computer networks to assign seemingly trivial tasks to less experienced staff, such as an instruction to turn off the access to a data warehouse server by the R&D department. While this added burden does create job security, it also undesirably drives up the cost of experienced administrators.

Attempts at providing a more convenient and less cumbersome method for defining and implementing security policies for computer networks have been made.

For example, U.S. Pat. No. 6,005,571, entitled “Graphical user interface for managing security in a database system”, to Pachauri, filed on Sep. 30, 1997, introduces a method for graphically administrating security policies with regards to actions that may be carried out by users of database systems.

However, such attempts fail to overcome the shortcomings described hereinabove.

Thus, there is a need for a method or an apparatus for formulating and implementing a security policy that may be easily utilized by a network administrator.

Preferably, with such a method or an apparatus the administrator may easily define a security policy, and correlate the security policy with implementations of the policy at the technical level, without excessive engagement in the technical details at each device specific level.

Further, there is a need for a policy management mechanism in which a policy may be defined once and applied to numerous devices or technology instances.

Furthermore, there is a particular need for such a mechanism in which security policies may be ported from one device or network to another, without having to repetitively carry out the same detailed configurations but rather concentrate at the true differences between the policies applied to each device or network.

Current methods and systems also fall short of providing the means for abstractly defining a high level business security policy and automatically implementing the defined policy throughout an entire computer network or computer installation.

There is thus a widely recognized need for, and it would be highly advantageous to have, an apparatus and method which are devoid of the above limitations.

### SUMMARY OF THE INVENTION

According to one aspect of the present invention there is provided an apparatus for computer network management, comprising: a knowledge definer, operable for defining a knowledge module comprised of a plurality of knowledge items, hierarchically arranged according to technologies implemented on the computer network, each of the knowledge items comprising possible values for a configuration activity of one of the technologies, and a policy definer, associated with the knowledge definer, operable for defining at least one technical policy based on the knowledge module, usable for overriding selected values of the possible values while keeping remaining values of the possible values, the technical policy inheriting from the knowledge module.

According to a second aspect of the present invention, there is provided a network configuration control apparatus comprising a configuration controller, operable by a user for customizing a configuration defined by knowledge items, each knowledge item comprising possible values for a configuration activity of a technology in the network.

According to a third aspect of the present invention, there is provided a method for computer network management, comprising: a) defining at least one knowledge module comprised of a plurality of knowledge items, hierarchically arranged according to technologies implemented in the computer network, each of the knowledge items comprising possible values for a configuration activity of a respective one of the technologies; and b) defining at least one technical policy based on the knowledge module, usable for overriding selected values of the possible values while keeping remaining values of the possible values, the technical policy inheriting from the knowledge module.

Preferably, the method further includes detecting and resolving conflicts existing between meta-polices or between technical policies, say when conflicting policies are assigned to technology instances implemented on the same device.

According to a fourth aspect of the present invention, there is provided a conflict detection apparatus for detecting conflicts between technical policies in a computer network, comprising: a conflict detector, configured to detect a conflict between at least two technical policies implemented on the computer network.

According to a fifth aspect of the present invention, there is provided an apparatus for computer network management, comprising: a translation definer, operable for defining a translation between at least one language directive and at least one respective configuration activity.

According to a sixth aspect of the present invention, there is provided a method for system configuration of a network or elements thereof, comprising: a) generating database items for each one of a plurality of configurations of the network or network element; b) forming the database items into a knowledge base of the network; and c) configuring the network or elements thereof by selecting one of the database items from the knowledge base.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a block diagram of a first apparatus for computer network management according to a preferred embodiment of the present invention;

FIG. 2 shows an exemplary GUI interface page presenting a knowledge module, according to a preferred embodiment of the present invention;

FIG. 3a is a block diagram illustrating a system for computer network management according to a preferred embodiment of the present invention;

FIG. 3b is a diagram illustrating a simplified architecture of a system for computer network management according to a preferred embodiment of the present invention;

FIG. 4 is a block diagram illustrating a second apparatus for computer network management according to a preferred embodiment of the present invention;

FIG. 5 is a simplified flowchart illustrating a method for computer network management, according to a preferred embodiment of the present invention;

FIG. 6 is a flowchart illustrating inheritance logic for an instance policy union, according to a preferred embodiment of the present invention;

FIG. 7 is a flowchart illustrating a policy union iteration method according to a preferred embodiment of the present invention;

FIG. 8 is a flowchart illustrating an instance policy union iteration method according to a preferred embodiment of the present invention;

FIG. 9 is a flowchart illustrating a device policy union iteration method according to a preferred embodiment of the present invention;

FIG. 10 is a flowchart illustrating a simplified method for conflict detection and resolution according to a preferred embodiment of the present invention;

FIG. 11 is a flowchart illustrating a simplified method for conflict resolution according to a preferred embodiment of the present invention;

FIG. 12 is a simplified exemplary data model scheme for policies and conflicts, according to a preferred embodiment of the present invention;

FIG. 13 is a flowchart of a first exemplary business policy translation scheme;

FIG. 14 is a flowchart of a second exemplary business policy translation scheme;

FIG. 15a is a flowchart illustrating a translation process according to a preferred embodiment of the present invention;

FIG. 15b is a simplified flowchart of a translation method according to a preferred embodiment of the present invention;

FIG. 16 is a simplified flowchart of a compliance method according to a preferred embodiment of the present invention;

FIG. 17 is a simplified exemplary data model scheme for language translation, according to a preferred embodiment of the present invention;

FIG. 18a shows a GUI page presenting language directive mapping, according to a preferred embodiment of the present invention;

FIG. 18b shows a GUI page presenting a translation policy's technical policy assignment, according to a preferred embodiment of the present invention;

FIG. 18c shows a GUI page presenting a conflict detected between two technical polices, according to a preferred embodiment of the present invention; and

FIG. 18d shows a GUI page presenting translation results for a language directive, according to a preferred embodiment of the present invention.

### DESCRIPTION OF THE PREFERRED EMBODIMENTS

The present embodiments comprise an apparatus and a method for computer network management.

An apparatus and a method according to a preferred embodiment of the present invention aims at providing Security Configuration Management (SCM) in a way that allows security configurations to be defined by the user/administrator and automatically enforced on devices in the computer network.

Preferably, a user of the apparatus is allowed to define technical policies relating to security configuration activities. The technical policies define configuration activities to be automatically performed, or reference values for configuration activities to comply with. The configuration activities relate to technologies implemented on devices in the computer network.

Preferably, the apparatus and method support the creation of several layers of policies including, but not limited to—a generic policy for a certain technology, a union of technology policies, policies that are specifically tailored for a certain instance of technology on a specific device, etc.

Preferably, the apparatus further provides an inheritance mechanism between the above described layers, such that the layers may be based one on the other, or assembled one from two or more others. Through the inheritance mechanisms there are provided flexibility and efficiency, as the user or administrator only has to deal with the differences between the inheriting layer (such as a technical policy) and the layer inherited from.

More preferably, the apparatus and method further allow the translation and mapping of language directives into low level technical policies. Language directives are guidelines which are formulated in a high level business policy language. The language directives define a Meta Policy abstracting the low level technical policies in a high level business language. The Meta Policy directives are guidelines to be complied with or enforced. The technical policies, in turn, directly define configuration activities to be carried out for implementing the business policy language directives, or values the technical policies are to comply with.

An apparatus according to a preferred embodiment of the present invention facilitates defining a knowledge module which serves to define configuration activities of technologies implemented on a computer network.

The technologies may include, but are not limited: an operating system, a database management system, an e-mail server, a storage area network (SAN), a switch, a firewall, etc.

The knowledge module includes knowledge items.

A knowledge item holds values for a certain configuration activity of a certain technology which is implemented in the computer network.

Optionally, the values held may be used for automatically carrying out the configuration activity. Alternatively, the values may be used as reference values for the configuration activity to comply with.

The knowledge items are arranged in a hierarchy. Preferably, the hierarchy emulates a structure of a certain technology that the knowledge items relate to. For example, the Windows registry is organized in folders and keys. As a result knowledge items concerning Windows registry configuration activities may be organized using the same folder and key names. This allows multiple users to find information easily and avoid duplication of data entry. The knowledge items may be found in the lower levels of the sub-hierarchy.

The apparatus further facilitates defining a technical policy, based on a knowledge module.

A technical policy defines a modified version of the knowledge module.

The technical policy overrides some of the knowledge items in the knowledge module by a replacing its values with new values, thus providing a new version of the knowledge module.

Optionally, one or more of the technical policies may be assigned, by a user of the apparatus, to a technology instance in the computer network.

A technology instance is a certain technology implemented on a specific device in the computer network. The technology instance may be, but is not limited to an operating system on a specific desktop pc, a database management system on a specific server, etc.

By assigning technical policies to a technology instance, the technical policies become active for the technology instance and are to be executed for the technology instance, as described in further detail herein below. The execution may include auditing or enforcing the technical policies or the directives abstracting the technical policies into a Meta Policy comprised of one or more directives, as described in greater detail herein below.

The principles and operating of an apparatus and a method according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

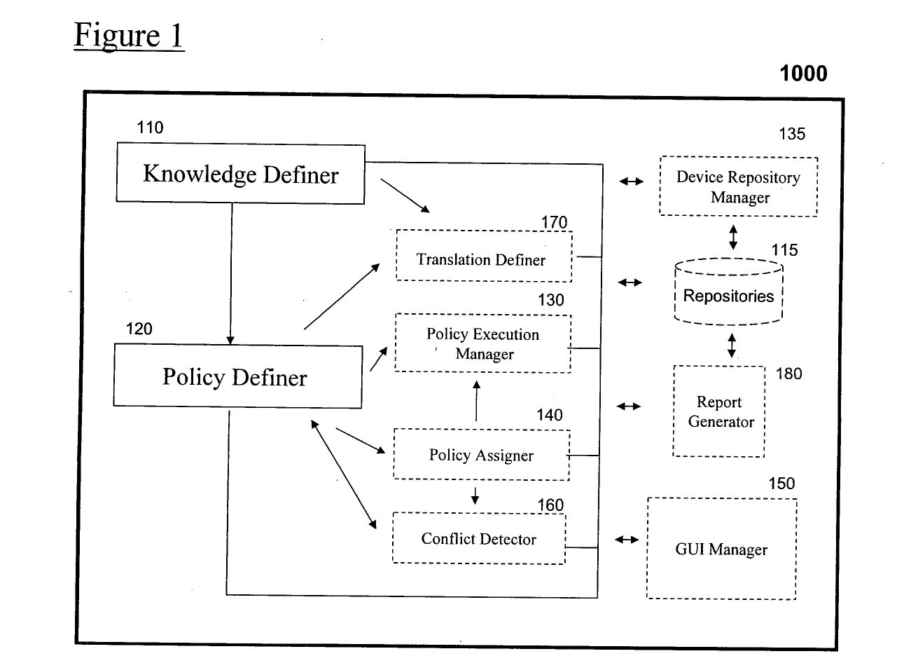

Reference is now made to FIG. 1 which is a block diagram of a first apparatus for computer network management according to a preferred embodiment of the present invention.

An apparatus 1000 according to a preferred embodiment of the present invention includes a knowledge definer 110 for defining a knowledge module (KM). Each KM hierarchically represents security configuration activities at a technical level and a policy definer 120, for defining specific technical policies based on the knowledge module.

Preferably, the apparatus 1000 may also include a policy execution manager 130—for managing the execution of the policies on devices, a policy assigner 140—for assigning the defined technical policies to technology instances on devices, a GUI Manager 150—for managing an interface between a user (or an administrator) and the apparatus 1000, a conflict detector 160—for detecting conflicts between policies, a translation definer 170—for defining a translation between an abstracted higher level business security policy to technical policies, a report generator 180—for generating reports providing information regarding security, a device repository manager 135—for managing and updating a repository of devices, repositories 115—for storing information generated by one or more of the above, or any combination thereof.

The apparatus 1000 is described in detail in the following paragraphs.

The apparatus 1000 according to a preferred embodiment of the present invention includes a knowledge definer 110.

The knowledge definer 110 is used to define a knowledge module (KM). The knowledge module is comprised of knowledge items (KIs), hierarchically arranged according to technologies (or platforms) in the computer network.

Preferably, each technology (or device) has its own knowledge module which describes the many configuration activities that may be carried out for the technology. The KM may also include the technical details needed for checks, enforcement, or rollback, to be carried out for the configuration activities.

Preferably, the hierarchical arrangement of the KI's in the KM emulates hierarchical structures which are characteristic of the technology. For example, in a Windows™ 2000 KM, KIs may be arranged in a structure which resembles the hierarchical arrangement of repositories in the Windows™ 2000 operating system.

Preferably, the knowledge module is then stored in a repository 115.

According to a preferred embodiment, each of the knowledge items (KIs) corresponds to a specific configuration activity on a specific technology. The technology may be but is not limited to: a Data Base Management System (DBMS), Firewall software implemented on a router, an Operating System, etc.

The knowledge item (KI) has the following types of attributes:

Descriptive attributes—these are text based attributes which convey information about the configuration activity to the user. The descriptive attributes may be used for querying as well as for filtering in reports, say by the report generator 180 described herein below, but do not effect actual policy execution.

Technical attributes—these attributes are specific to the type of the KI and convey the technical information that uniquely describes the configuration activity, by detailing the parameters that are passed to the technical Application Programming Interface (API) for analysis and enforcement.

The apparatus 1000 further includes a policy definer 120 connected to the knowledge definer 1 10.

Optionally, the policy definer 120 uses the repositories 115 described hereinabove, for retrieving knowledge module data, creating policy data, and storing the created policy data.

The policy definer 120 is used for defining one or more technical policies.

Each technical policy is directly or indirectly based on the knowledge module (KM).

Each technical policy directly or indirectly inherits from the knowledge module, as described herein below.

The technical policy is used to customize the KM by overriding selected knowledge items (KIs) of the KM with policy specific values, as described in detail herein below.

The policy definer 120 implements methods for defining policies and for inheritance between a technical policy and a knowledge module or between technical policies, as described in detail herein below.

Each of the technical policies may be classified as a deployment policy or as a compliance policy. A Deployment policy relates to automatically carrying out the configuration activities, defined in the policy, on devices or technology instances in the computer network. A compliance policy is used to check devices or technology instances in the computer network for compliance with the configuration activities as defined in the policy.

Optionally, a technical policy may be assigned a priority to be used for resolving conflicts between technical polices as described in greater detail herein below.

In a preferred embodiment, the technical policy inherits the hierarchal arrangement and the possible values from the knowledge items of a knowledge module as described in greater detail herein below.

The technical policy may also be based on and inherit from a previously defined technical policy or on a nest of technical policies that is based on and inherits from the knowledge module. The inheriting technical policy may override knowledge items of knowledge module or inheritance items overriding the knowledge items with new values, using an inheritance item. Optionally, any inheritance item may be flagged as final, thus blocking its overriding by other inheritance items.

The defined technical policy is used for overriding selected values of the possible values as described in the knowledge item, while keeping remaining values of the possible values as originally set at the level of the knowledge item in the knowledge module or in a previously defined technical policy, or in a nest of previously defined technical policies.

Preferably, the policy definition also includes priority of the policy, the policy deployment mode (auditing, enforcing, etc.) and other characteristics as defined in greater detail herein below.

Preferably, a technical policy only saves the overridden values whereas the inherited values which are not changed are kept only in the knowledge module, thus avoiding data redundancy and providing data integrity.

Preferably, through the process of defining the technical policy, the policy definer 120 communicates with the graphical user interface (GUI) manager 150 for presenting the technical policy to the user in an interface based on the hierarchical arrangement of KIs in the knowledge module.

Optionally, the policy definer 120 is further configured to use an iterator for iterating through the hierarchically arranged KIs in the knowledge module (KM), and the technical policies that are based on the knowledge module (KM).

That is to say, a system according to a preferred embodiment of the present invention allows defining technical policies that translate into configuration changes.

Each possible configuration change is described in a knowledge item (KI) 112 inherited from the knowledge module.

The KI describes a specific configuration activity for a specific technology, and what possible values exist for this change.

Optionally, the possible values of the inherited knowledge item are overridden by the technical policy as defined by the user. The overriding values are recorded as an inheritance item. An inheritance item is an item having the same where fields as the Knowledge Item (KI), but with the overriding values.

Preferably, the overriding of values by the technical policy inheritance item may have a time limit, defined by the user, as explained in further detail herein below.

The KI contains where fields describing the technical details of where the configuration change takes place. Optionally, some of the where fields are defined as primary key fields for the class of data object used for the KI. The defined primary key fields may be used for conflict detection, as explained in further detail herein below.

The where fields are also used as a conflict primary key to be utilized for detecting and resolving conflicts as described in greater detail herein below.

Optionally, the where fields may contain parameters that are to be resolved when the technical policy is assigned to a specific instance of technology on a specific device in the computer network of the enterprise.

The knowledge items are hierarchically arranged in the knowledge modules according to technologies or products.

As described herein above, a technical policy includes a chosen set of values from the possible value for one or more knowledge items in a specific knowledge module.

There are different types of Knowledge Items. Each type matches a different configuration Application Program interface (API) that is used for carrying out the configuration activity. The different types relate to the way the configuration change is made. Each type of Knowledge Item (KI) has different attributes according to the API used for carrying out the configuration activity.

The Knowledge Items usually reflect the underlying API properties directly, but sometimes the Knowledge Items contain an abstraction of the underlying API properties according to a way users often use for describing the specific configuration activity.

For example, Windows services are maintained in a registry. The original registry API may be used, but an abstraction is made on some of the API parameters, such that the user only has to know the service name and not all registry parameters for the service.

Other examples may be found in the UNIX world, where a lot of checks are based on a UNIX shell script. Instead of having the user write each script he needs, an abstraction is made for common actions—such as checking a file permission, ownership checks, etc. The abstraction is made by preparing in advance utility scripts which are run via the shell API.

According to a preferred embodiment, the policy definer 120 may also be used for defining a new technical policy based on a previously defined technical policy.

The new technical policy inherits from the previously defined technical policy all configuration activity data, except for data in KI fields that are overridden with new values. The overriding field values for each KI are recorded in an inheritance item, having the same structure as the KI being overridden with the new values.

In a preferred embodiment, the policy definer 120 may also be used for defining a technical policy union. A technical policy union joins one or more technical policies, creating a joint policy.

The technical policy union inherits all the KIs in the technical policies joint in the union. The user may then choose to override a KI with new values to be recorded in an Inheritance Item, as described hereinabove with respect to the technical policy.

The technical policy union may bear potential conflicts between two or more of the technical polices joint in the technical policy union. More specifically, the potential conflicts may exist between two or more K's. The conflicts may be detected and resolved as described in greater detail herein below.

Preferably, the apparatus 1000 further includes a policy execution manager 130, connected to the policy definer 120.

The policy execution manager 130 is used for managing execution of the policies on devices in the computer network. The execution of a compliance technical policy includes checking that the configuration of technology instances installed on the device follows the policy as relating to the device. The execution of deployment policies includes automatically carrying out the configuration activities, as defined in the policies, on technology instances installed on the device. Preferably, policies may be checked with respect to a device even if the policies are not explicitly assigned to the device.

Optionally, the execution of the policies may be carried out directly by the policy execution manager 130, say when implementing the policy execution manager 130 as an agent manager connected to centrally installed device specific execution agents.

More preferably, the execution of a policy on a device is carried out by an execution agent, installed on the device.

The execution agent may be configured to communicate the policy execution manager 130 and automatically carry out the execution of the policies relevant to each technology instance implemented on the device, according to the communication with the policy execution manager 130.

Preferably, the execution agent is a generic agent, which may be configured to support any current or feature technology.

Preferably, the apparatus 1000 further includes a device repository manager 135.

The device repository manager 135 is used for creating and updating a device repository 115. The device repository 115 stores information relating to devices in the computer network and to technology instances implemented thereon.

Optionally, the device repository 115 may also be used by a policy assigner 140, for retrieving information relating to technology instances implemented on devices, and for assigning policies to the technology instances, as described in further detail hereinabove.

Preferably, the device repository manager 135 is configured to automatically discover a device in the computer network and technology instances implemented on the device. The device repository manager 135 may then automatically update the device repository with information relating to the device, the technology instances implemented on the device, and instance parameters for the device.

According to a preferred embodiment of the present invention, the apparatus 1000 further includes a policy assigner 140, connected to the policy definer 120.

The policy assigner 140 may be used for assigning the technical policy to a specific instance of technology on a specific device in the computer network. Optionally, the policy assigner 140 uses the device repository 115, for retrieving information relating to the instance policy and the device, as described hereinabove.

Preferably, the policy assigner 140 may also be used for assigning the technical policy to a group of instance(s) or device(s). Optionally, the group may be a static group comprised of a fixed list of instance(s) or devices(s). Preferably, the group may be a dynamic group comprising a dynamic list of instance(s) or device(s). For example, the technical policy may be assigned to all devices or instances starting with a* or to all instances of a certain technology.

The policy assigner 140 may also be used for assigning two or more technical polices to a specific instance of technology on a specific device in the computer network. Optionally, the assigned technical policies may include technical policies that are already joint in a technical policy union.

By assigning two or more technical polices to the instance, the policy assigner 140 implicitly creates an instance policy union for the instance. The instance policy joins the assigned technical policies thus creating a joined technical policy for the instance.

The instance of technology may be, but is not limited to a Data Base Management System (DBMS) implemented on a specific server, a Firewall software implemented on a certain router, an operating system on a desktop PC, etc. The instance of technology may also be a sub-technology such as an interface of a router, a table-space in a database, etc.

Utilizing the below described GUI manager 150, the user is able to override a KI in one of the knowledge modules the assigned technical policies are based on, with new values. The new values are recorded in an inheritance item having the same structure as the KI, as described hereinabove with respect to defining a technical policy.

Instance policy unions behave like the technical policy union described hereinabove, with the following differences:

a) As described hereinabove, some technical policies may include knowledge items having where fields with parameters to be resolved at the technology instance level. Upon assigning the technical policies to the same technology instance, the parameters are resolved based on the same technology instance, thus potentially raising conflicts between the policies, which now have the same where values, as discussed in greater detail herein below.

b) As described hereinabove, a technical policy union inherits from all policies joint in the policy union. However, an instance policy union further inherits from instances of technology in a hierarchy of technology instances that are implemented at the specific device (the instance's parent instances). As a result, inheritance works differently for an instance policy union than for a technical policy union, as described in greater detail herein below.

The policy assigner 140 may also create a device policy union. The device policy union exists for each device and is created automatically by joining all technical polices assigned to all technology instances on the same device in the computer network. The device policy union may also have inheritance items which override values which are set at the level of the instances on the device.

According to a preferred embodiment of the present invention, the apparatus 1000 further includes a graphical user interface (GUI) manager 150, connected to the policy definer 120 and the knowledge definer 110.

The graphical user interface (GUI) manager 150 is configured to manage interactions of the apparatus 1000 with the user, utilizing interfaces as described in the following paragraphs.

The GUI manager 150 is configured to provide an interface for interaction of the knowledge definer 110 with the user for defining the knowledge module (KM) including the various knowledge items (KIs) describing the configuration activities, and the hierarchical arrangement of the KIs.

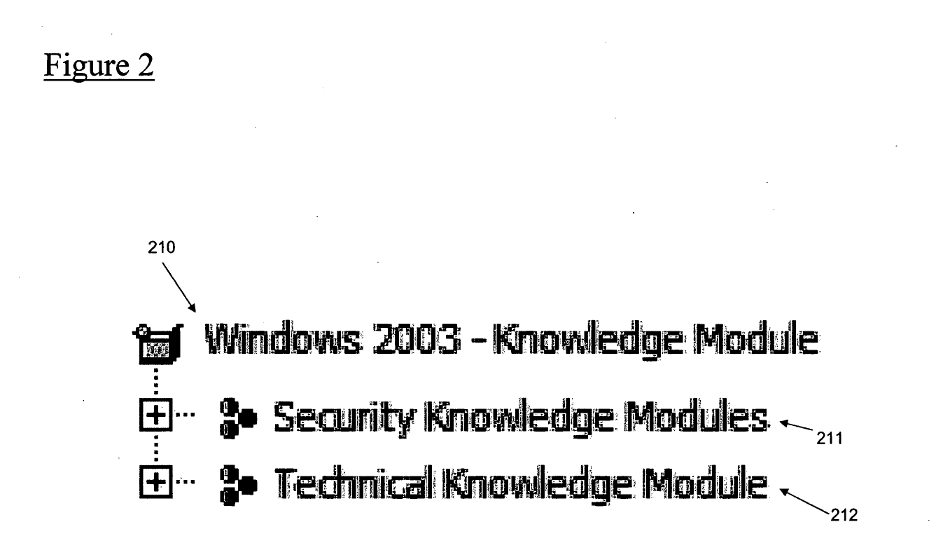

Reference is now made to FIG. 2 which shows an exemplary GUI interface page presenting a knowledge module, according to a preferred embodiment of the present invention.

The exemplary GUI interface is used for interaction of a user with the knowledge definer 110.

The KM is presented to the user as a hierarchy 210 which includes a single sub-hierarchy 211 representing a physical view of the security knowledge recorded in KM. The hierarchy 210 may further include one or more sub-hierarchies representing a logical view 212 of the security knowledge in the KM.

Preferably, the first sub-hierarchy is organized in a very strict manner which tries to emulate a technology structure exactly. For example, Windows registry is organized in folders and keys. As a result security knowledge concerning Windows registry may be organized using the same folder and key names. This allows multiple users to find information easily and avoid duplication of data entry. The knowledge items may be found in the lower levels of the sub-hierarchy.

The other sub-hierarchies are logical. Optionally, a logical sub-hierarchy of does not contain any KI, but rather points at the KIs in the first sub-hierarchy. The pointing allows a more friendly and comfortable organization of security knowledge. Multiple logical sub-hierarchies may be used in order to organize knowledge in ways that are suitable to different tasks or users.

Preferably, the GUI manager 150 is also configured to provide an interface for interaction of the policy definer 120 with the user for defining one or more technical policies based on the knowledge module. The interface is based on the hierarchical arrangement of K's as inherited by the technical policy from the knowledge module.

That is to say, the technical policy is displayed to the user through an interface such that the technical policy appears similar to the knowledge module, specifically with respect to the hierarchical arrangement of the KIs in the knowledge module.

The GUI manager 150 is also used to provide an interface for interaction of the policy assigner 140 with the user for assigning technical policies including technical policies which are joint in technical policy unions to technology instance(s) in the computer network. The assignment of technical policies to a specific technology instance implicitly brings about the creation of an instance policy union assigned to the specific instance, as described hereinabove.

The GUI manager 150 may also be used by the policy definer 120 to interact with the user for defining or modifying a technical policy union. The GUI manager 150 may also be used by the policy assigner 140 for defining or modifying an instance policy union, or a device policy union.

The GUI manager 150 may further provide an interface combining the hierarchical arrangements in the knowledge modules that the technical policies joined in the union inherit from.

By interacting with the policy definer 120 or the policy assigner 140, through the interface provided by the GUI manager 150, the user may choose a KI and override data in some of its fields with new values. The new values are recorded in an inheritance item having the same structure as the KI, as described in greater detail herein below.

According to a preferred embodiment of the present invention, the apparatus 1000 further includes a conflict detector 160.

The conflict detector 160 is configured to detect conflicts among one or more technical policies joint in a common policy union.

The common policy union may be a technical policy union—explicitly created by the user utilizing the above described policy definer 120, an instance policy union—implicitly created when the user assigns technical policies to a certain technology instance using the policy assigner 140, or a device policy union—automatically created by the policy assigner 140, as described hereinabove.

A first type of conflicts may occur for two or more different KIs having the same values in their where fields—before or after parameters resolution in accordance with instance specific assignment of the technical policies.

A second type of conflict is a logical conflict which may arise between K's s differing in one or more of their where fields. Such a conflict may arise when the conflicting K's relate to different configuration activities but are pre-defined as Potential Logical Conflicts. The Potential Logical Conflicts are user made definitions of conflicts between different configuration activities that may create a problem when implemented together.

According to a preferred embodiment the conflict detector 160 is further configured to resolve the detected conflicts.

The conflict detector 160 may be configured to implement conflict detection and resolution methods, described in detail herein below.

According to a preferred embodiment of the present invention, the apparatus 1000 further includes a translation definer 170.

The translation definer 170 is operable for defining a translation of a language directive to one or more KIs, each of the KI describing a configuration activity, as discussed in further detail hereinabove.

A language is comprised of language directives (or statements). The directives are used to create an abstraction of the different configuration activities as defined using technical terminology in the knowledge modules. Using language directives, a high level policy may be defined by managers, and then be translated (or mapped) to a technical policy as defined hereinabove.

Optionally, the translation definer 170 may also be used for defining a translation between two language directives.

For example, a general language directive dictated by a president of a company may translate into several department specific directives say for the R&D department and for the System Administration department.

In another example, a directive from a first language may be re-used to define a directive from a second language. In the example, a language B relating to an International Standards Organization (ISO) standard is defined. There is previously defined a directive named Web Vulnerabilities, and there is previously defined a directive named DB Vulnerabilities, both in a security language A. When defining the B language an ISO directive is assigned the two directives described above.

The translation definer 170 is configured to implement translation methods and conflict resolution and detection methods, as described in greater detail herein below.

Preferably, the apparatus 1000 further includes a report generator 180. The report generator 180 may be used to generate various reports providing information regarding security issues as currently defined and implemented in the computer network.

More preferably, the report generator 180 is also used for generating reports relating to compliance with regulation standards, auditing reports, etc.

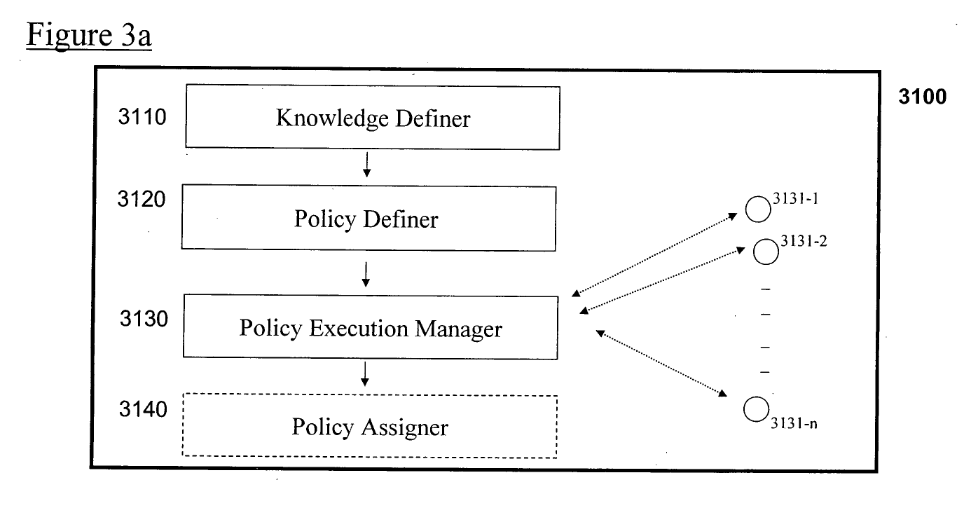

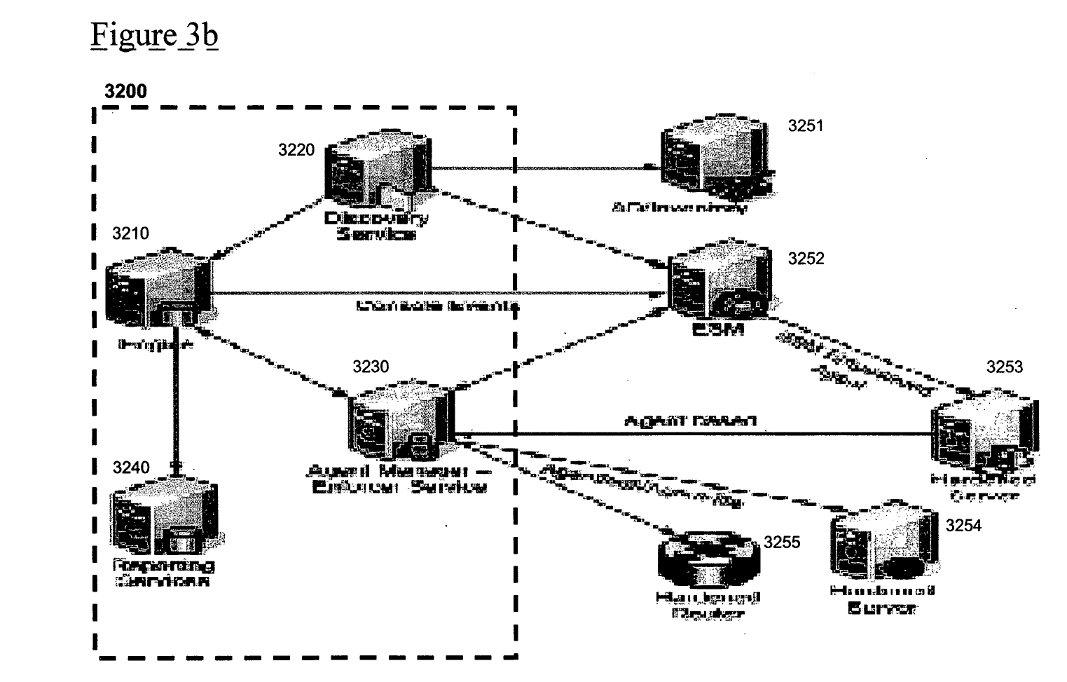

Reference is now made to FIG. 3a which is a block diagram illustrating a system for computer network management according to a preferred embodiment of the present invention.

A system 3100 according to a preferred embodiment of the present invention includes a knowledge definer 3110.

The knowledge definer 3110 is used to define a knowledge module which is comprised of knowledge items, hierarchically arrange according to technologies, as described in greater detail hereinabove, for apparatus 1000. Optionally, each knowledge item comprises possible values relating to one of the technologies, as described hereinabove.

The system 3100 also includes a policy definer 3120, connected to the knowledge definer 3110 and used for defining a policy based on, and inheriting from the knowledge module, as described in greater detail hereinabove.

The system 3100 further includes a policy execution manager 3130 which is connected with the policy definer 3120 and configured to manage the execution of the defined polices on devices in the computer network.

The system 3100 further includes one or more device agents 3131-1-3131-n.

Each device agent 3131-1-3131-n is implemented on a specific device in the computer network. The device agent communicates with the policy execution manager 3130, and executes the policies defined by the policy definer 3120 with regards to the technology instances which are implemented on the device.

Preferably, the system also includes a device repository manager and a policy assigner, as described hereinabove for apparatus 1000.

Reference is now made to FIG. 3b which is a diagram illustrating a simplified architecture of a system for computer network management according to a preferred embodiment of the present invention.

A system 3200 according to a preferred embodiment of the present invention may be implemented utilizing a distributed architecture.

According to a preferred embodiment, the system implements central components such as the knowledge definer 3110 and the policy definer 3120 on a central engine server 3210

Preferably, a discovery service may be implemented in a dedicated server 3220. The discovery service is configured to detect any device in the computer network and update the central engine server 3210 with information relating to the device and technology instances which are implemented on the device.

Optionally, the policy execution manager 3130 is implemented as an agent management enforcement service on a second server 3230.

The policy execution manager 3130 may communicate with device agents for managing the execution of policies defined by the policy definer 3120 with respect to the device. Each device agent is deployed on a certain device such a server 3253.

The policy execution manager 3130 may also directly enforce the defined policies on servers 3254, in an agent-less manner, thus executing the defined policies itself.

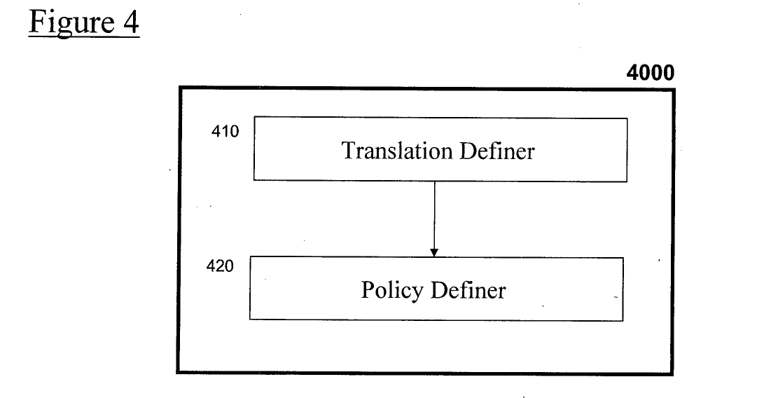

Reference is now made to FIG. 4 which is a block diagram illustrating a second apparatus for computer network management according to a preferred embodiment of the present invention.

An apparatus 4000 according to a preferred embodiment of the present invention includes a translation definer 410.

The translation definer 410 is used to define a translation of one or more language directive(s) into configuration activities, as described in greater detail herein below.

Optionally, the language directives are defined in an abstracted higher language security policy, as described hereinabove.

Preferably, the translation definer 410 is also used to define a translation of one language directive to another language directive, thus supporting a multi-layered translation, as discussed in further herein below.

Preferably, the configuration activities are defined at a technical level, utilizing knowledge modules, and technical policies, as described in greater detail herein below.

Preferably, the apparatus further includes a translator 420.

The translator 420 is configured to translate the language directive(s) to the configuration activities, utilizing the defined translation.

The translator 420 and the translation definer 410 may implement the translation methods described in detail herein above.

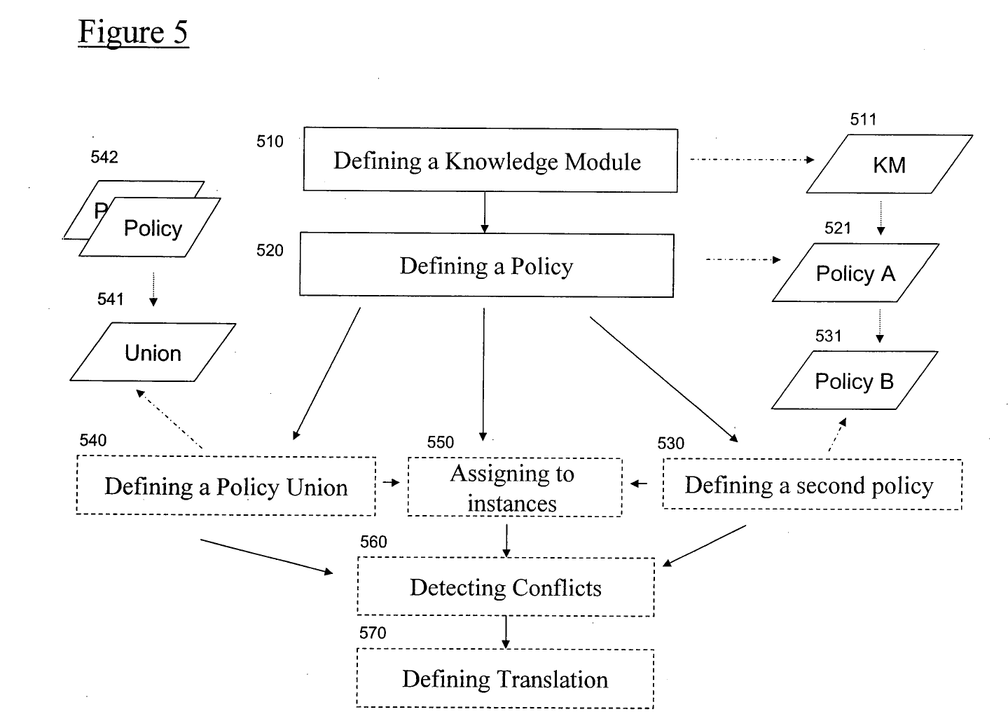

Reference is now made to FIG. 5 which is a simplified flowchart illustrating a method for computer network management, according to a preferred embodiment of the present invention.

First, one or more knowledge module(s) 511, comprised of a two or more Knowledge Items (KIs) are defined 510. The KIs in each KM are arranged in a hierarchy set according to technologies. Each of the KIs records possible values for a configuration activity relating to one of the technologies. Optionally, the knowledge module(s) 511 are stored in a knowledge repository.

Then, one or more technical policies 521 are defined. Each policy 521 is directly or indirectly based on a knowledge module 501 and inherits from the knowledge module. The technical policy is usable for overriding selected knowledge items with new values, while keeping other knowledge items unchanged.

Preferably, the policy inherits from the knowledge module 511 the KIs as well as the hierarchical arrangement of the KIs.

Next, there may be defined 530 a second technical policy 531, based on and inheriting from the previously defined technical policies 521.

Optionally, there may be defined 540 one or more technical policy union(s) 541, as described in greater detail hereinabove. A technical policy union comprises two or more technical policies 542, as described in greater detail hereinabove.

Next, one or more technical policies, technical policy union(s), or a combination thereof may be assigned 550 to a technology instance on a device in the computer network, as described in greater detail hereinabove.

As discussed above, the assignment of the technical polices or technical policy union(s) to the specific instance brings about the creation of an instance policy union. Also as discussed above, a specific device policy union is automatically generated by joining all technical policies and technical policy unions assigned to the specific device in the computer network.

Optionally, a method according to a preferred embodiment of the present invention may also include detecting 560 conflicts between policies joint in a technical policy union, an instanced policy union, or a device policy union, as described in greater detail herein below. Preferably, the method further includes resolving the conflict, as described in greater detail herein below.

The method may further include defining 570 a translation between a language directive and one or more configuration activities. Each configuration activity may be defined using a KI, as described hereinabove.

Preferably, the method further includes defining a translation between language directives.

A translation of directives in various languages may then be made, utilizing the defined translations, as described in greater detail herein below.

Policies and Inheritance Methods

According to a preferred embodiment of the present invention, a technical policy may inherit directly from a Knowledge Module (KM). The technical policy may inherit indirectly from the Knowledge Module (KM), by inheriting from a previously defined technical policy or from a nest of one or more previously defined policies, one of which directly inherits from the Knowledge Module (KM).

An inheritance method according to a preferred embodiment of the present invention implements the same hierarchical arrangement for the Knowledge Module (KM) and for the technical policy inheriting from the Knowledge Module (KM).

Furthermore, an inheritance method according to a preferred embodiment of the present invention may include overriding values in any KI in the hierarchy of KIs in the knowledge module.

That is to say that unlike traditional inheritance methods where inheritance relates only to classes and not to objects, a method according to a preferred embodiment of the present invention allows inheriting and overriding objects such as KIs as well as object hierarchies such as KI hierarchies.

In a preferred embodiment, the technical policy has a Policy Base Object field defining the object which the policy directly inherits from, say a Knowledge Module, or another policy, as described hereinabove.

As described above, the new values which override the data in the KI as inherited from the KI are recorded in an Inheritance Item.

Preferably, the Inheritance Item includes the following fields:
Base Object—the specific KI overridden by the Inheritance Item (as opposed to the Policy Base Object of the Policy which actually defines KM or policy).
Starting Date—the date from which the item is active and overrides the KI.
Expiration Date—the date when the item stops being active and no longer override the KI—this field and the Starting Date field allow setting some items in the policy to be active in a time frame defined by the dates and to expire without a manual intervention at the end of the time frame
Overridden fields and their new values—these are the new values overriding the KI field values.

As described hereinabove, the GUI manager 150 provides an interface used by the policy definer 120 for presenting the technical policy to the user as a hierarchy of inheritance items. The presented hierarchy is similar to the hierarchy of KIs as defined for the Knowledge module and inherited by the technical policy. Each Inheritance Item uniquely relates to a specific KI.

Through the presentation, an inheritance item which is devoid of overriding values is temporally presented to the user a proxy object. The proxy object provides a mediation interface between the user and an object which does not necessarily exist when the proxy object is presented to the user.

A real Inheritance Item is created only upon the overriding of the KI with new values, as described hereinabove.

When the presented proxy or real Inheritance Item is queried for its values, say when the user double clicks on the Inheritance Item, the overriding values that the Inheritance Item contains for each field in the KI are presented to the user. If there are no overriding values for the field, the values of the KM itself are presented instead.

A policy may inherit from a previously defined policy. If a policy inherits from a previously defined policy, the policy also inherits the Policy Base Object from a previously defined policy. The Policy Base Object is the knowledge module the policy is based on and inherits from.

For example, if policy A inherits from a policy B, which implements a policy base object C, then when policy A is defined or modified via the interface implemented by the GUI manager 150, as described in greater detail hereinabove:
The Inheritance Items of policy A for all the hierarchy of base object C are fetched.
When an Inheritance Item of policy A is queried for its field values, it checks if it has overriding attributes, and if not, it uses the value for the field returned by its underlying policy B.
Policy B returns an Inheritance Item for the required base object, and checks if it has overriding attributes to be returned. If not, it uses the value for the field returned by original base object in policy base object C.

Preferably, each Inheritance Item may be defined as final. Upon defining the Inheritance Item as final, no inheriting policy may create Inheritance Items to override its values.

An instance policy union is implicitly created by joining technical policies, some of which may already be joint in a policy union, when the policy unions are assigned to a common technology instance, as defined hereinabove.

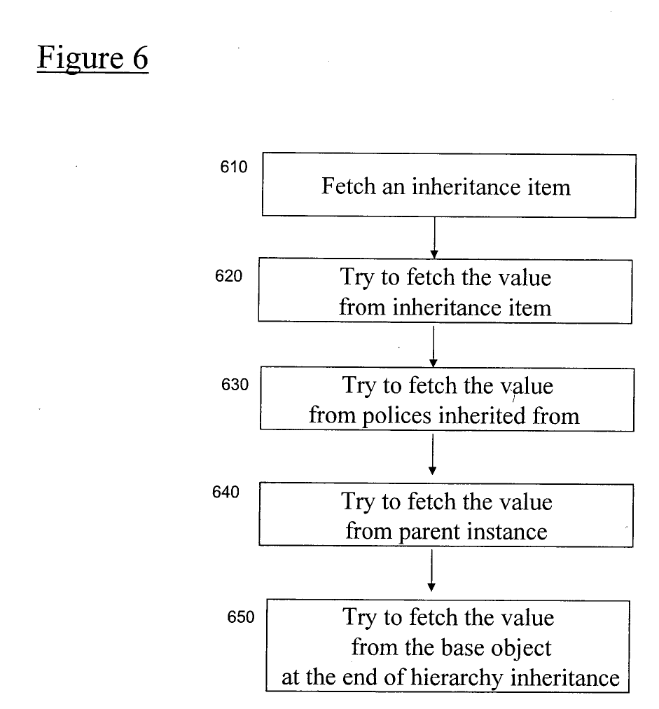

Reference is now made to FIG. 6 which is a flowchart illustrating inheritance logic for an instance policy union according to a preferred embodiment of the present invention.

The inheritance of the policies assigned to instance follows a change in inheritance logic:
An Inheritance Item for the policy union is retrieved for each base object 610
When retrieving the value for a field of the Inheritance Item, the following order is used:
Try to fetch the value from the Inheritance Item of the Instance Policy Union 620.
Try to fetch the value from the Policies and Policy Unions assigned to the Instance Policy Union.
If the Policies inherit from other Policies, try to fetch the value from all of the inheritance hierarchy of policies 630.
But—as opposed to the logic of Policy Inheritance—do not fetch the value from the real Base Object at the end of the inheritance hierarchy.
If no value is fetched from the Inheritance Item of the Instance Policy Union or its assigned Policies, try to fetch it from the Instance Policy Union of the parent Instance of the current Instance using the same logic 640.
Only if there is no Parent Instance, fetch the value from the real Base Object 650.

Since a policy union may join two or more technical polices, there may be found conflicts between two or more of the technical polices. The conflicting policies may include conflicting configuration activities as defined by the certain KIs.

According to a preferred embodiment, all conflicts are detected and resolved prior to iterating through the technical policies joint in the policy union and implementing inheritance on the policy union.

Preferably, conflict detection and conflict resolution are carried out according to one or more of the methods described in detail herein below.

According to a preferred embodiment of the present invention, a policy union is presented to the user by the policy definer 120 through an interface managed by the GUI manager 150. The interface is similar to the interface which is used to define the knowledge module, as the interface is based on the hierarchical arrangement of the KI in the inherited knowledge module (KM).

In order to implement the interface, the policy definer 120 may utilize a policy union multi-iterator.

The policy multi-iterator iterates through policy iterators. Each policy iterator is configured to iterate through one of the policies joint in the policy union. Since there may be conflicts between KIs in the different policies, as described hereinabove, the multi-iterator may also check for conflicts, say utilizing the conflict detector 160 discussed hereinabove. The multi-iterator may also return a preferred KI, resolving the conflict, say utilizing the conflict detector 160, as described hereinabove.

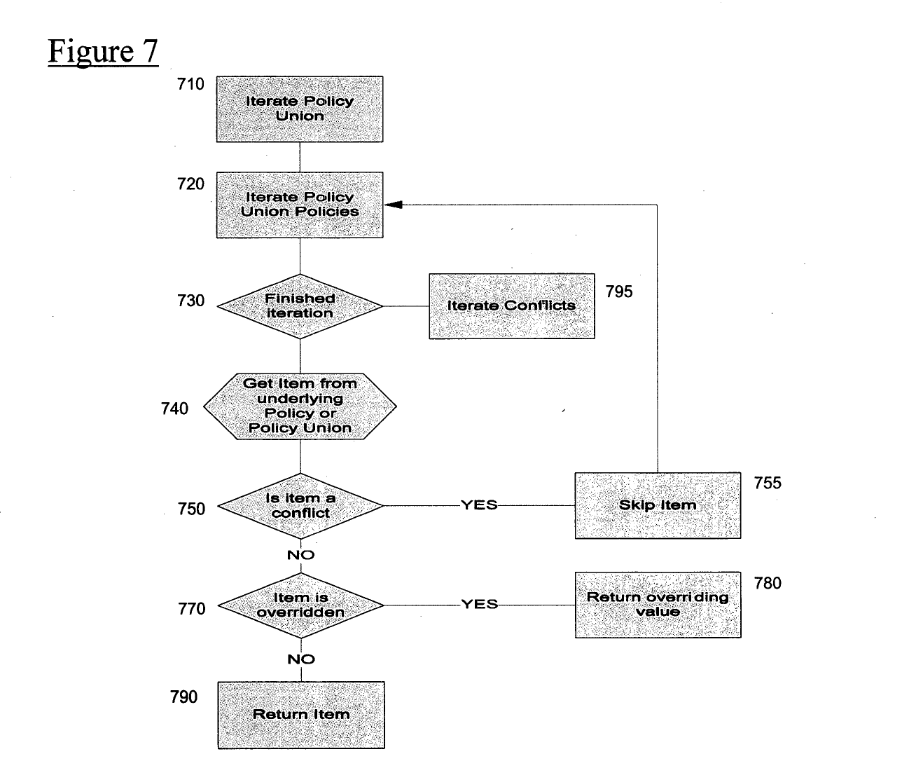

Reference is now made to FIG. 7 which is a flowchart illustrating a policy union iteration method according to a preferred embodiment of the present invention.

A method according to a preferred embodiment of the present invention starts iterating through the policy union 710.

First, the method iterates through the technical policies assigned to the policy union 720. Each Knowledge Item (KI) from each underlying policy or policy union is fetched 740. If the fetched item is in a conflict 750 (as defined herein below), the item is skipped 755. If the item in not in a conflict, then if the KI is overridden 770 by an inheritance item as described hereinabove, the overriding values recorded in the inheritance item are returned to the user 780, otherwise—the original item values are returned to the user 790.

After iterating through all items in the policy union 730, an iteration is made through all items skipped because of a conflict. The conflicts are resolved in accordance with the methods described herein below, say by the above described conflict detector 160.

According to a preferred embodiment of the present invention, the policy assigner 140 presents an instance policy to the user through a hierarchical interface provided by the GUI manager 150.

The policy assigner 140 implements an instance policy union multi-iterator.

The instance multi-iterator works similarly to the policy multi-iterator.

The policy multi-iterator uses the same logic as the multi-iterator of the policy union. However with the instance multi-iterator, conflict is checked only after KI instance dependent parameters are resolved in accordance with the technology instance the policies are assigned to.

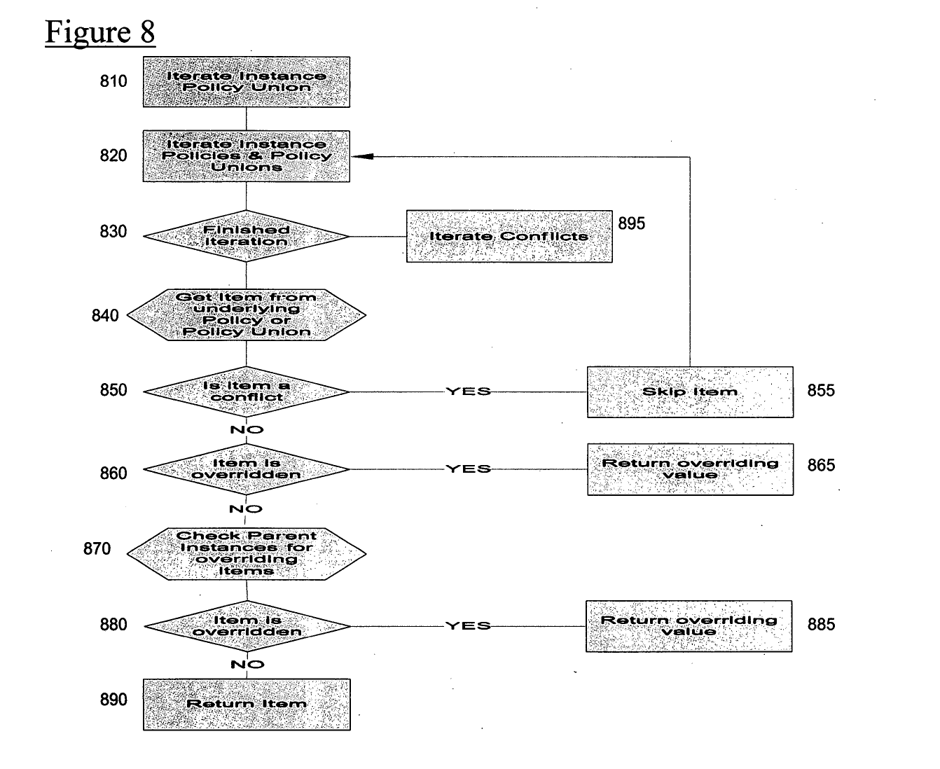

Reference is now made to FIG. 8 which is a flowchart illustrating an instance policy union iteration method according to a preferred embodiment of the present invention.

A method according to a preferred embodiment of the present invention starts iterating through the instance policy union 810.

First, the method iterates 820 through the instance policies and policy unions assigned to the technology instance. Each Knowledge Item (KI) from each underlying policy or policy union is fetched 840. If the fetched item is in a conflict 850 (as defined herein below), the item is skipped 855. If the item in not in a conflict, then if the KI is overridden by an inheritance item 860 as described hereinabove, the overriding values recorded in the inheritance item are returned to the user 865,

If the item is not overridden by an inheritance item at the level of the policy, a check is made with at the parent instances 870. That is to say, a check is made in technology instances that are higher an hierarchy of technologies instances in the computer network, as defined by the user, say using known in the art network management products. If the item is overridden by overriding items in a parent instance 880, the overriding values are returned 885 for the item. Otherwise—the original item values are returned to the user 890.

After iterating through all items in the instance union 830, an iteration is made through all items skipped because of a conflict. The conflicts are resolved in accordance with the methods described herein below, say by the above described conflict detector 160.

The policy assigner 140 may also implement a device policy union multi-iterator and utilize a hierarchical interface provided by the GUI manager 150, for presenting the device policy union to the user.

The device multi-iterator is used for iterating through all technical policies assigned to all technology instances as described in detail hereinabove. In a preferred embodiment, the device multi-iterator iterates through instance multi-iterators. Each instance multi-iterator then iterates through the technical policies assigned to the specific technology instance, as described hereinabove.

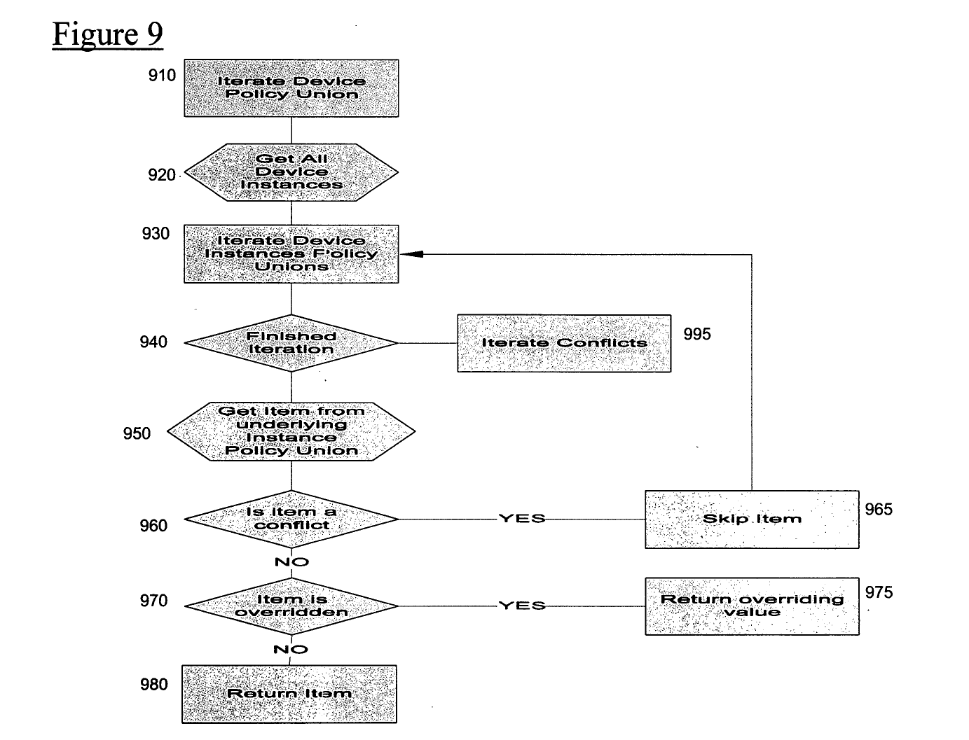

Reference is now made to FIG. 9 which is a flowchart illustrating a device policy union iteration method according to a preferred embodiment of the present invention.

A method according to a preferred embodiment of the present invention starts iterating through the automatically created device policy union 910.

First, a list is made 920 of the technology instances implemented on the device. Then, iteration is made 930 through all the instance policy unions of the technical polices assigned to the instances implemented on the device.

All KIs of the instance policy unions are fetched 950. If a KI is an item in conflict with another KI 960, the item is skipped. If the KI does not conflict, then if the item is overridden by an inheritance item 970—the overriding values in the inheritance module are presented to the user, otherwise—the original KI values are returned to the user 980.

After iterating through all items 930, iteration is made through all items skipped because of a conflict. The conflicts are resolved in accordance with the methods described herein below, say by the above described conflict detector 160.

Conflict Detection and Resolution Methods

As described in detail hereinabove, two or more technical policies may be joined in a union, be it a technical policy union, an instance policy union, a device policy union, etc.

The joint policies may bear conflicts. If the policies contain KIs having the same where data, there may be a potential conflict if the two KIs bear different what values. If the KIs bear the same values, the KIs create a duplicate, to be removed.

Conflicts may also be detected at an abstracted higher language level.

When language directives are assigned technical policies, the assigned technical policies may be conflicting. That is to say that compliance policies or regulation policies, defined in language directives using a higher language, are also checked for conflicts, based on their assigned technical policies and knowledge items, as described in detail herein below.

Specifically, the conflict may be found between the same Knowledge Item (KI) in different policies, or between different Knowledge Items (KIs) with potentially the same where properties. The where fields need not be identical, but only potentially identical since they may contain parameters that may later be resolved to become identical.

For example, a user may assign different policies or policy unions to an Instance. If the assigned policies contain Knowledge Items with possibly the same parameterized where information, there is a potential conflict, since after resolving the parameters at the instance level, they may contain the same where information, and the user may select a different what value for them. Furthermore, event if the Knowledge Items have the same what values, they are still duplicates, to be identified and removed.

Parameters at the instance level are defined separately from the policies, and their usage in the policy is resolved on demand.

Two or more instances of technology may be implemented on the same specific device. Each instance is assigned with policies as described hereinabove.

After resolving the parameters in the different instance policies, a conflict may occur between the where properties of an Knowledge Item (KI) in policies on different Instances on the Device.

There may also be Logical Conflicts.

Logical Conflicts are conflicts between different Knowledge Items that have different where properties, but are defined as logically conflicting. They are called Logical Conflicts since they create some logical problem in the resulting configuration if they are implemented concurrently. For example one knowledge item may define a particular network service as active and a second knowledge item may define the same service as inactive. If a system is to be configured based on both of these knowledge items together then the conflict must be resolved.

Logical Conflicts are also called Relations, since they map Relations between different Knowledge Items.

According to a preferred embodiment of the present invention, the user may define logical conflicts that may exist between two Knowledge Items having different values on both where values and what values if the two knowledge items are implemented together.

Preferably, the defined logical conflicts are stored in a logical conflict repository. The logical conflicts definitions are used to prevent the user from choosing, in the policies, values for the conflicting knowledge items, such that a logical problem arises in the resultant configuration.

According to a preferred embodiment, for each defined logical conflict there are recorded proposed selected what values for each Knowledge Item (KI) in the conflict, and the level of certainty that the proposed values are correct.

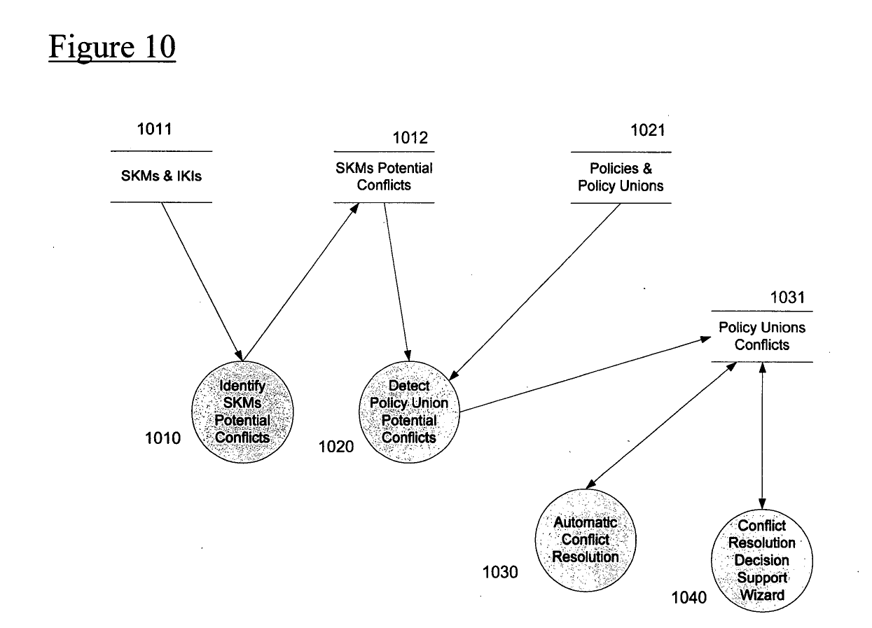

Reference is now made to FIG. 10 which is a flowchart illustrating a simplified method for conflict detection and resolution according to a preferred embodiment of the present invention.

According to a preferred embodiment, all knowledge modules 1011 are analyzed 1010 to detect different Knowledge Items having potentially identical where fields. Any two Knowledge Items having identical where fields are kept in a potential conflict repository 1012.

Any two Knowledge Items having where fields that contain parameters which may be resolved to be identical are kept in the potential conflicts repository 1012 with a flag to indicate that the conflicts are potential conflicts with parameters to be resolved.

Specifically, the detection of instance policy union potential conflicts takes place only after the instance parameters of the where fields are resolved. With instance policy unions all checks for conflicts are carried out for all KIs in all knowledge modules of the policies and policy union assigned to the technology instance. Policy unions assigned to the instance are resolved, as described herein below, prior to the process carried out for detecting conflicts in the instance policy union.

Device policy unions are checked for conflicts, taking into consideration all K's of all knowledge modules of all policies and policy unions of all instance policy unions of all the instances in the device. As with instance policy unions, all policy union assigned to any of the technology instances implemented on the device are resolved prior to carrying out the checks for conflicts in the device policy.

Preferably, for each policy union 1021, all the KIs in all the Knowledge Modules of all the policies in the policy union are examined 1020 for conflicts.

Policy union conflicts records are created for groups of Knowledge Items in the union that are present in the potential conflict repository 1221 as potential conflicts. The union conflict records are stored in a policy conflict repository 1031.

Policy union conflict records are also created and stored 1031 for KIs that appear in more than one policy in the policy union and are not included in other policy union conflict groups. However, this step is not carried out for device policy unions, since the same KI may appear for two instances on the same device.

As explained hereinabove, all potential conflicts are detected and recorded, including duplicate KIs, so as to avoid presenting the user a duplicate KI.

Furthermore, logical conflicts records are created for KIs that are detected as conflicting according to a logical conflict repository, as described hereinabove.

Preferably, an automatic conflict resolution 1030 is carried out for the detected and recorded policy union conflicts 1031, say by the conflict detector 160 implementing the below described methods.

More preferably, a conflict resolution decision support wizard is implemented 1040 by the conflict detector 160, utilizing the GUI manager 150. The wizard allows the user to modify and approve the results of the conflict resolution process carried out by the conflict detector 160.

According to a preferred embodiment, the detected conflicts are automatically resolved, to later be presented to the user for modifications and approval 1040, using the wizard. Each automatically resolved conflict is assigned a certainty level, to help the user in the analysis of the suggestions made by the conflict detector 160.

According to a preferred embodiment, the following methods may be used to solve the conflicts.

Conflict resolution may be performed in a loop, until no more conflicts are left unresolved. Preferably, such an embodiment implements a deadlock prevention and detection mechanism to prevent endless looping, utilizing methods as known in the art.

Preferably, the loop is performed first on the KI configuration action field—indicating the action that is to be taken when implementing the KI (for example, Set means changing an already defined parameter in the configuration activity and Add means adding a new parameter).

Next, the loop is performed for the what value fields. Finally, the loop is performed for the selected what remediation level (policy status) field—indicating if the values are to be enforced by automatically carrying out configuration activities according to the values, or by checking compliance of configuration activities with the values.

Through the above order the conflicts between different possible actions for the same KI are dealt with first, then all conflicting K's having this selected action but different values, and finally conflicting KIs having different remediation level (policy status).

Optionally, in order to help Conflict Resolution Decision Support Wizard described herein below, the loop may be performed for all possible actions, and not only for the selected ones. This allows the user to modify the automatic resolution results, if the user opts to do so. That is to say, by performing the loop for all possible actions in advance, a user is allowed to choose different actions without having to wait for the loop to be performed separately for each of the actions he chooses.

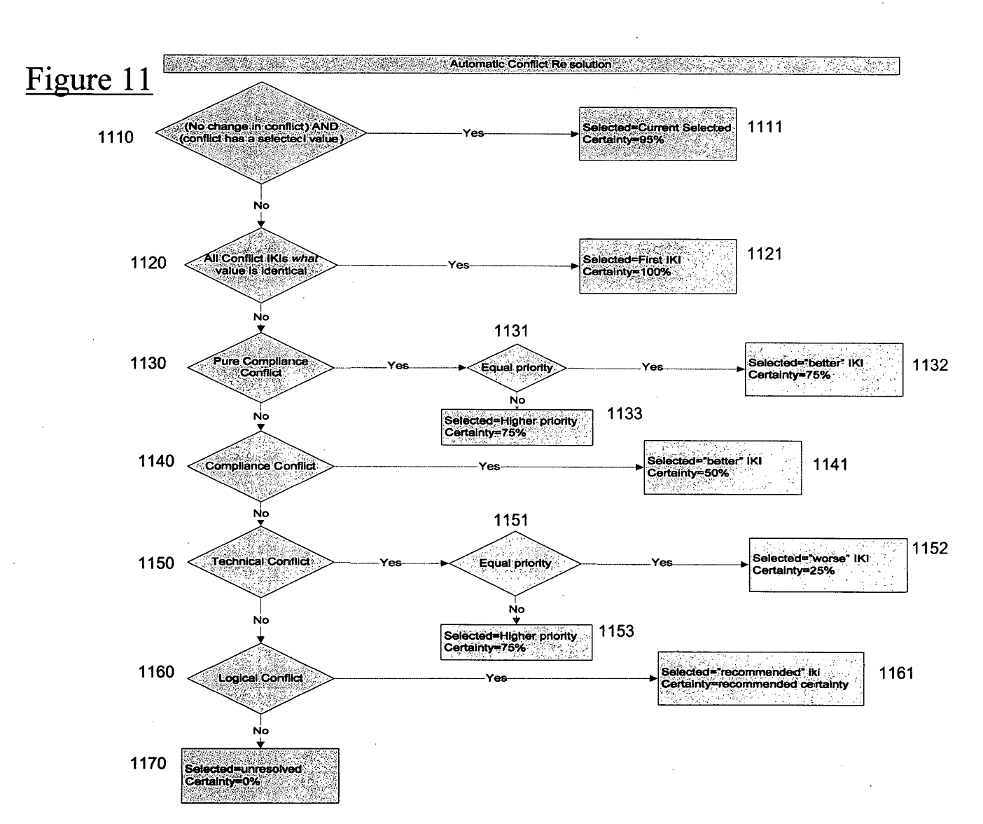

Reference is now made to FIG. 11 which is a flowchart illustrating a simplified method for conflict resolution according to a preferred embodiment of the present invention.

According to a preferred embodiment, the automatic conflict resolution is carried out, say by the conflict detector 160, according to the following logic:

If there is no change in the Knowledge Items in the conflict 1110 (say, when the user tries to solve a conflict on a device for a second time, or when the user assigns a new policy to an instance on the device, and tries to solve conflicts involving the knowledge item though the item's values are not changed), and there is a previously approved selected value for the conflict—use the previously approved value with a 95% certainty 1111.

If all the Knowledge Items in the conflict have the same selected what values 1120 then the knowledge items are duplicates defining identical configuration activities, in terms of doing what and where, and one of them is chosen, say the first one 1121—they are identical and are considered a resolved conflict which eliminates duplicates, and has a 100% certainty.

If the conflict is between Knowledge Items which are both in compliance policies, this is considered a pure compliance conflict 1130—a conflict between directives, and the value from the policy with the higher priority is selected 1133. If the two policies have the same priority 1131, the value with the Knowledge Item (KI) with the better (as explained herein below in the weighting section) what value is selected 1132, as the better value represents a more conservative approach. This is done with a certainty of 75%.

If the conflict is between a knowledge item in a policy classified as compliance policy, and a Knowledge Item (KI) in a policy classified as deployment policy, this is a compliance conflict 1140. In a compliance conflict we choose the Knowledge Item (KI) with the better (as explained herein below in the weighting section) selected what value 1141—even if it is the one which is in the deployment policy. This is done with a certainty of 50%.

If the conflict is between Knowledge Items which are both in deployment policies, this is considered a technical conflict 1150, and we choose the value from the policy with the higher priority 1153. If the two policies have the same priority, we select the value with the Knowledge Item (KI) with the worse (as explained herein below in the weighting section) what value 1152. This is done with a certainty of 25%.

If the conflict is a Logical Conflict, as per the definition hereinabove, then for each Knowledge Item (KI) in a Logical Conflict 1160, we select a proposed what value which is defined in the Logical Conflict record 1161. The level of certainty is set according to the level of certainty defined in the Logical Conflict. If a conflict solution is changed back and forth during the loop and fails to reach a steady state, the conflict is marked unresolved with a certainty of 0% 1170, and utilizing the wizard, the user is prompted to select a preferred KI among the KIs in the unresolved conflict, as described herein below.

All the decisions made during the automatic conflict resolution process are logged and presented to the user to review and approve.

According to a preferred embodiment of the present invention, each conflict is documented in a conflict record.

The record may include, but is not limited to:

a list of all items in the conflict,

the selected base object—the item chosen when resolving the conflict,

the selected based object policy—the policy or policy union selected when resolving the conflict,

the selected instance—which instance is selected to resolve the conflict (relevant only to conflicts in a device policy union—implicitly created from all policies and unions assigned to the instances on the device), and

an update flag—indicating a change in the list of conflicting objects.

Upon such a change, the user may have to revisit the conflict record for reconsidering the conflict's resolution.

According to a preferred embodiment, following the automatic conflict resolution, the conflict resolution support wizard is implemented to present the results of the automatic conflict resolution to the user.

The wizard is also used to prompt the user to review and approve the results. The wizard may be implemented by the conflict detector 160, communicating with the user through an interface provided by the GUI manager 150.

In a preferred embodiment, the wizard has the following screens:

1. All conflicts between KIs having different actions, and which actions are chosen.

a. The user is presented with:
i. The level of certainty of the automatic resolution
ii. The logic for the current decision (which rule in the automatic conflict resolution was used).

b. The user may ask to see further details, and may then be shown screens for the following:
i. What action is chosen for each rule (i.e., the last chosen, the compliant action, etc.)
ii. The actions for each different policy.

c. The user may change the selected action for each conflict, and is prompted to select an action for the consequent unresolved conflicts:
i. If the user changes the selected action for a conflict, the wizard performs the automatic conflict resolution logic again for the conflict.
ii. In order to avoid performing the automatic conflict resolution logic again in the wizard, the automatic conflict resolution keeps the results for each possible selected action, such that the wizard has all the information it needs.

2. All conflicts between KIs having different values, and which values were chosen for the KIs.

a. The wizard provides the user with:
i. The level of certainty of the automatic resolution of the conflict that has been chosen, say 50%, 60%, 100%.
ii. The logic to the current decision, that is to say which rule was used to make the selection for the automatic conflict resolution discussed above.

b. The user may ask to see details, and thus be shown:
i. What value is chosen for each rule (i.e., the last chosen, the compliant action, etc.).
ii. The values for each different policy.

c. The user may change the selected value for each conflict, and is prompted to select a value for the unresolved conflicts.

3. All conflicts involving KIs having different remediation level (policy status).

a. The user is shown:
i. The level of certainty of the automatic resolution.
ii. The logic for the current decision (which rule in the automatic conflict resolution).

b. The user may ask to see details, and be shown:
i. What remediation level is chosen for each rule (i.e., the last chosen, the compliant action, etc.)
ii. The remediation level for each different policy.

c. The user may change the selected remediation level for each conflict, and is prompted to select a remediation level for the unresolved conflicts.

According to a preferred embodiment, the above described methods are also used for detecting and resolving conflict between technical polices used for translation of the same language directive, when defining a translation, as described in greater detail herein below.

Weighting

According to a preferred embodiment of the present invention, during the conflict resolution process, the knowledge item (KI) values are weighted, such that a decision may be made whether a given KI field value is better or worse than a second KI field value, as described in greater detail hereinabove, using FIG. 11.

The weighting of the values may based on a various known in the art criteria including but not limited to: a scoring function (linear, normal, user defined, or another), normalization (conditional) functions, a positive flag indicating if a positive is good or bad, an allowed range, user defined metrics that may support special values, etc.

A Data Model

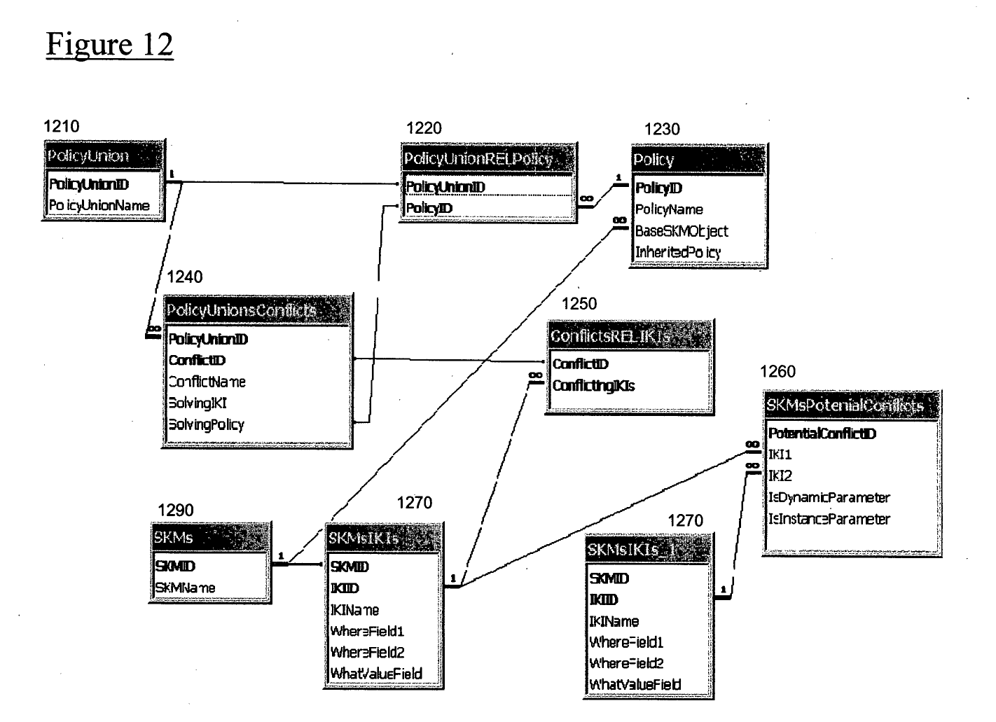

Reference is now made to FIG. 12 which is simplified exemplary data model scheme for policies and conflicts, according to a preferred embodiment of the present invention.

An exemplary data model according to a preferred embodiment of the present invention includes a policy union data table 1210—including a unique policy union number and a policy union name.

The model also includes a policy union related policy table 1220—listing the technical policy assigned to the union.

The model further includes a policy table 1230—holding for each policy: the policy unique number, a policy name, a base object—the knowledge module the policy is based on, and an inherited policy if relevant.

The model also includes a knowledge module table 1290—listing knowledge models.

The model also includes a policy union conflict table 1240—for recording conflicts found for a certain conflict, a conflict KI table 1250—holding the list of knowledge items relating to each conflict found for the union, as well as a KI table 1270—holding a unique KI number, a name, and values for each of the knowledge items.

The model further includes a potential conflict table 1260 listing potential conflicts and associated with the IK table 1270 holding data for KIs in the potential conflicts.

Language Translation Methods

According to a preferred embodiment of the present invention, there is provided a method supporting the translation of business policy language directives into technical polices and knowledge items as described hereinabove above.

According to a preferred embodiment of the present invention, there are provided Language Translation Modules. A Language Translation Module allows defining translations between two different Languages, or between Languages and Knowledge Modules.

The translation occurs by mapping between Language Directives in the different Languages, or between the Language Directives and the Knowledge Items in the Knowledge Modules.

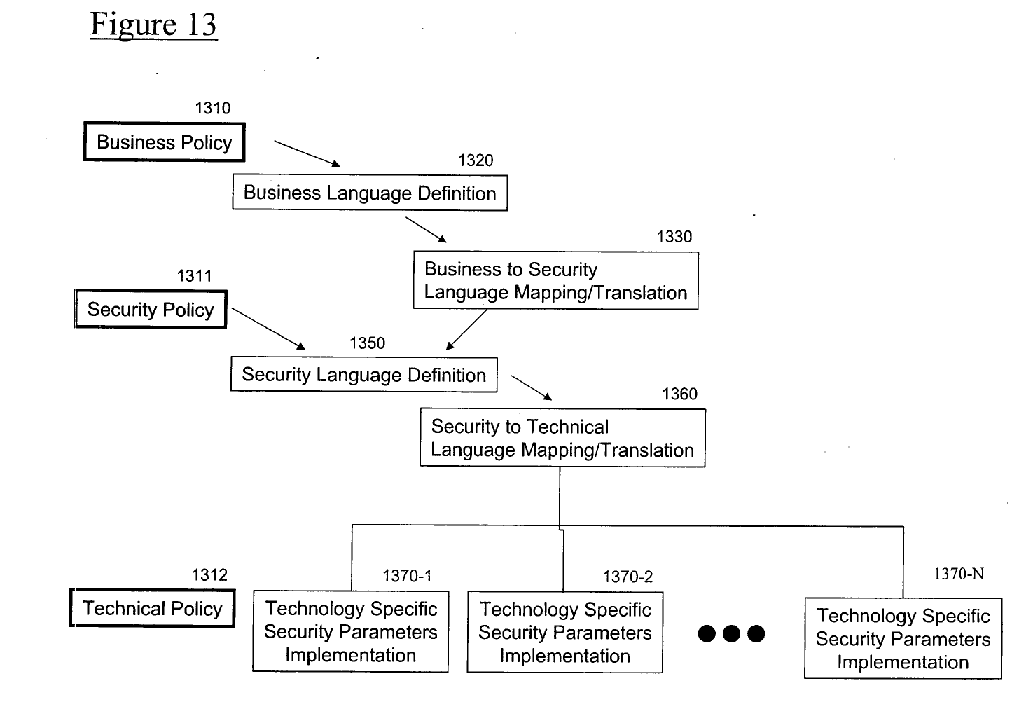

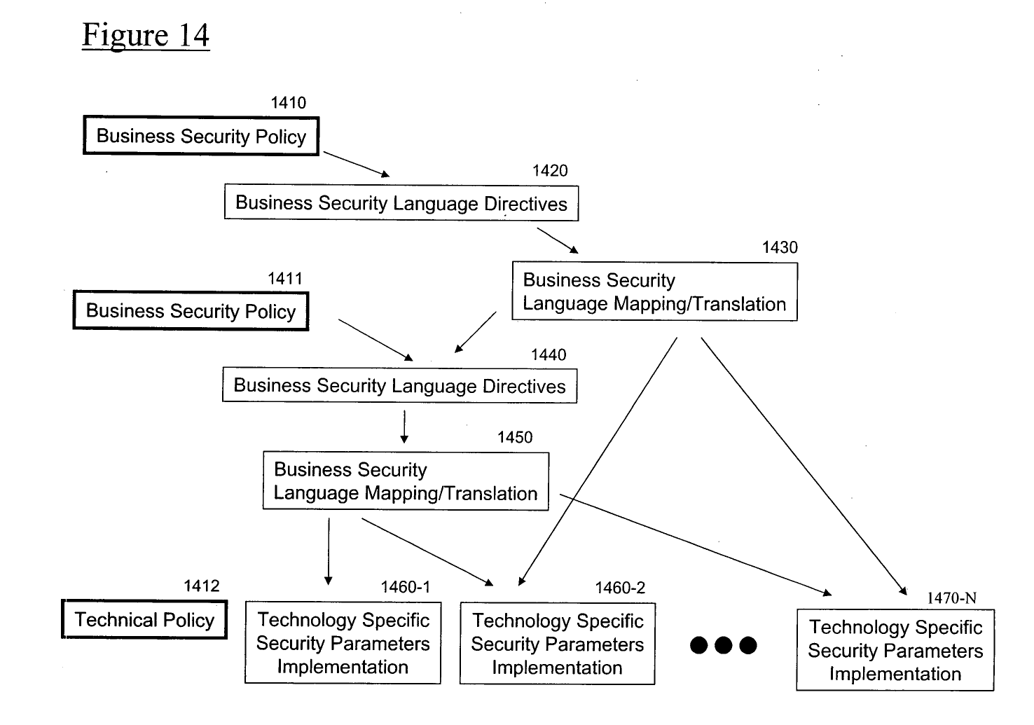

The result is a multilayered translation mechanism which enables the creation of higher level directives and languages, abstracting the underlying details of the configuration level Knowledge Items, as illustrated and explained using FIGS. 13-14 in the following paragraphs.

Reference is now made to FIG. 13 which is a flowchart of a first exemplary business policy translation scheme.

In a first example, a business policy 1310 may include a business language definition 1320.

The business language definition 1320 may be translated (or mapped) 1330 to a security language definition 1350 in a security policy 1311.

Then, the security language definition 1350 may be translated (or mapped) 1360 to one or more technology specific parameters 13701-1-1370-N in a technical policy 1312—such as the above described technical policies.

Reference is now made to FIG. 14 which is a flowchart of a second exemplary business policy translation scheme.

In a second example, business security language directives 1420 of a first business security policy 1410 in a first language may be translated 1430 to business security language directives 1440 in a second business security policy 1411 in a second language, thus implementing a two layered translation.

Then, the business security language directives 1440 of the second policy 1411 are translated or mapped 1450 to technology specific security parameters 1460-1-1460-N in a technical policy 1412.

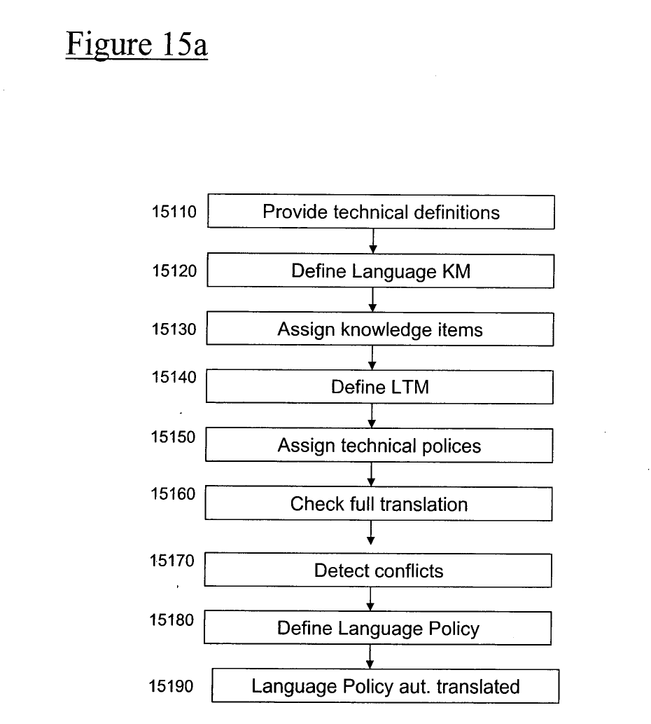

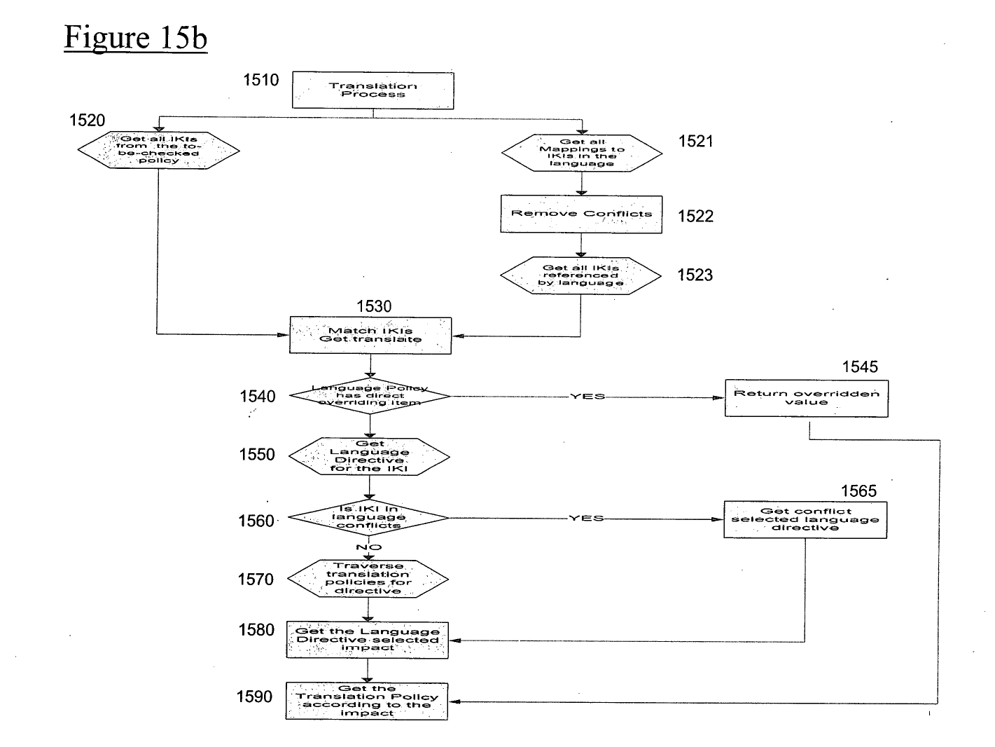

Reference is now made to FIG. 15a which is a flowchart illustrating a translation process according to a preferred embodiment of the present invention.

According to a preferred embodiment of the present invention, the translation definition process may include the following steps.

First the user provides 15110 technical definitions: knowledge items, technical policy, policy unions, etc.

Then, the user defines 15120 a Language Knowledge Module (Language KM).

The Language Knowledge Module is similar to the above described KM but consists of Language Directives (LDs) that behave similarly to KIs. Optionally, the LDs are hierarchically arranged in the Language Knowledge Module.

The user assigns 15130 each Language Directive a list of all Knowledge Items (KIs) from all Knowledge Modules (KMs) that bear relevance to the Knowledge Language Directive, thus mapping the KIs as Translation Items for the directive.

Then, the user defines 15140 Language Translation Modules (LTM) for the Language Directives. Each LTM is assigned Translation Policies.

Each Translation Policy corresponds to one of possible impacts, criteria, or categories (for example—Low, Medium, or High) that may be selected for the directive.

Then, the user assigns 15150 each translation policy with technical policies, or policy unions, for defining the translation of a directive to Knowledge Item values for the Knowledge Items mapped as Translation Items for the directive.

Alternatively, a translation policy may be assigned another language directive or another translation policy, thus facilitating a multi-layered translation, as explained in further detail herein below.

Preferably, there may be implemented a check 15160 to ensure that all the language directives and knowledge items that were assigned to the language directives in the language knowledge modules in previous step 15130 have been fully translated.

Optionally, there may be determined a scope for the check. For example, a scope may be defined such that only policies which are assigned to specific instances of a given device are taken into consideration for the above described check.

For example, if a Language A's directives are checked for translation into a specific knowledge module, two important checks are made:

1. That all language directives in Language A are translated into one or more knowledge item(s a language directive is not translated, then there are no knowledge items, in the knowledge module, that are usable for implementing the language directive, and the user is notified of the inability to translate the directives. Optionally, directives may be marked if they must be translated, or are only optional directives that are to be implemented on if translatable.

2. That all knowledge items assigned to the Knowledge Module are covered by the translation—if a knowledge item is not covered by the translation, then the user may be prompted to configure a directive manually.

Preferably, as there may be potential conflicts among overlapping technical policies assigned to the same Translation Policy or to the same Language Translation Module, a conflict detection and resolution process is carried 15170 out prior to translating the language directives, say by a translation definer, as described for policy union conflicts hereinabove

The conflicts may be detected and resolved according to the methods described in greater detail hereinabove.

Finally, the user may define a language policy 15180.

In the language policy the user selects, for each language directive, one of possible impacts, criteria, or categories.

For example, a language may allow the user to select between three categories—low, medium, and high, for each directive in the language.

The language policy is automatically translated 1590 to the relevant KI values, based on the defined LTM and the Language KM, as explained in greater detail hereinabove.

The user may then drill down the specific mapping and translation implied by the user's selection for each language directive. The user may choose to change some of the translation results, thus fine tuning the resultant translation and proofing the translation.

For each knowledge item the user changes, there is generated an inheritance item in the Translation Policy implied by the user selected option (impacts, criteria, or categories) with regards to the directive, as described hereinabove.

Reference is now made to FIG. 15b which is a simplified flowchart of a translation method according to a preferred embodiment of the present invention.

As the translation process starts 15 10, all the knowledge items and inheritance items from the policy to be checked are fetched 1520. In addition, all mapping to knowledge items in the languages modules is also fetched 1521, the conflicts are removed 1522, and then all knowledge items referenced by the language translation modules are fetched 1523.

Next, an iteration is started through the knowledge items of the language translation modules 1530, in the same manner as when iterating through a knowledge module, as described in detail hereinabove.

The following method steps are based on the assumption that we have a policy union, which is to be correlated with a language policy, for a language translation module.

For each knowledge item from the policy union, get the knowledge item what values from the language policy and if the language policy has a direct inheritance item for the knowledge item 1540, return the overriding values 1545 in the inheritance item.

The language directive in the language translation module for the knowledge item 1550 is then obtained. If the knowledge item is found conflicting 1560—then the selected language directive of the preferred KI of the conflict 1565 is obtained, otherwise—then the language policy—language translation modules—knowledge items mappings are checked to get the language directive the knowledge item was derived from1570.

Then, the translation policy according the resultant impact is fetched 1580: If the translation policy is a language policy, an attempt is made to get the knowledge item from the translation policy (recursively). If the translation policy is a technical policy or a technical policy union, the knowledge item values from the policy are fetched.

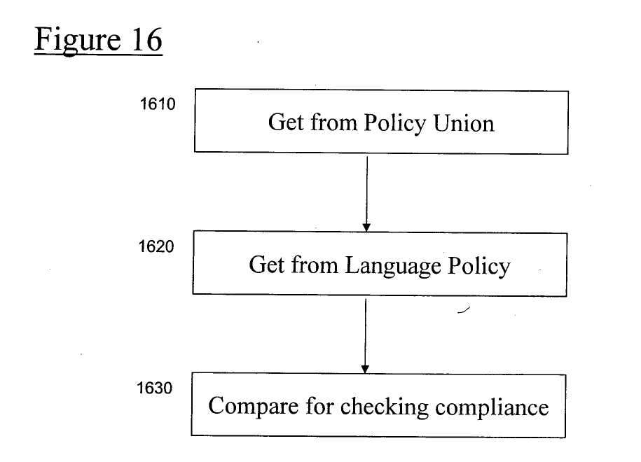

Reference is now made to FIG. 16 which is a simplified flowchart of a compliance method for knowledge items in a policy union according to a preferred embodiment of the present invention. The compliance method is to ensure that the different items in the same union do not conflict, and furthermore do not conflict with the governing language policy.

Language policy and technical policy unions are described hereinabove.

In a method according to a preferred embodiment of the present invention, the following steps are carried out for each knowledge item in the policy union:
get the knowledge item what values from the policy union 1610.
get the knowledge item what values from the language policy 1620.
compare the two values to decide if there is compliance between the policy union and the language policy 1630.

A Data Model

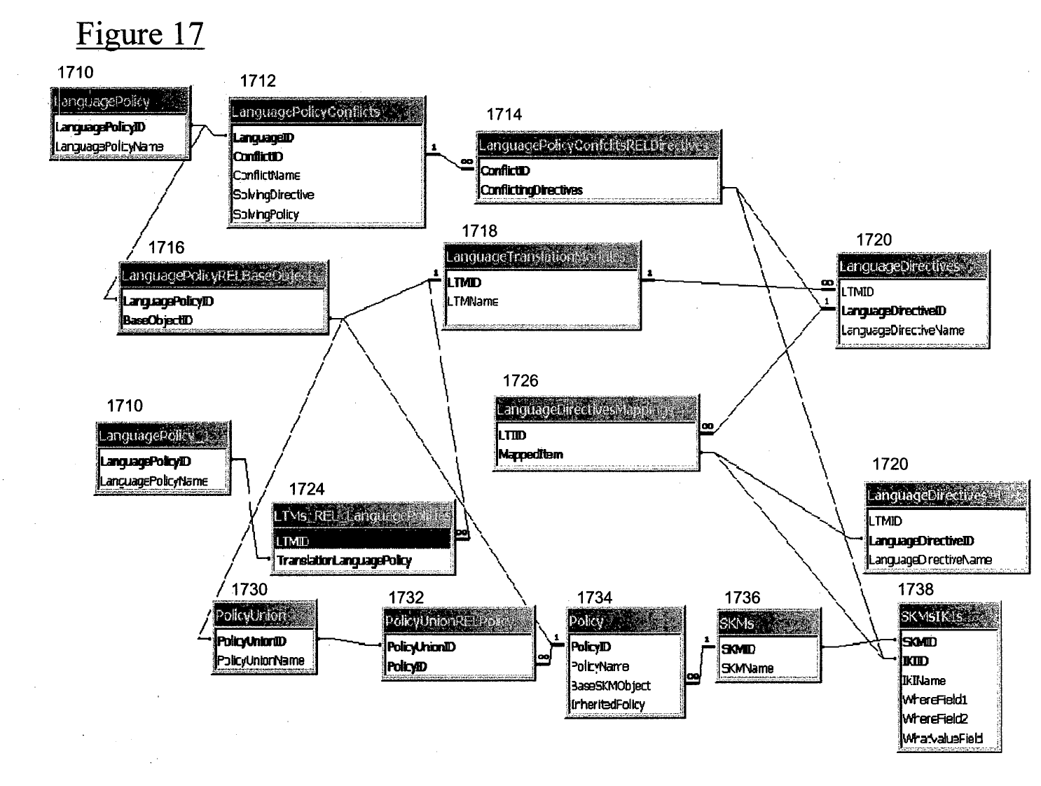

Reference is now made to FIG. 17 which is simplified exemplary data model scheme for language translation, according to a preferred embodiment of the present invention.

An exemplary data model according to a preferred embodiment of the present invention includes a language policy table 1710—holding for each policy a uniquely identifying number and a name, a language policy conflict table 1712—listing all conflicts found for the language policy, a language policy conflict directive table 1714—listing conflicting directives in a policy, a language policy base object table 1716—listing the base objects for the policy, a language directive table 1720—carrying a unique number identifying a directive, name of the directive, and further details for the directive, and a directive mapping table 1726—mapping knowledge items for each directive.

The model further includes a language translation module table 1718—recording a uniquely identifying key for the language translation module, and a name for each language translation module, and a language translation module policy table 1724—listing the technical policies assigned to the language translation module, which is associated with the language policy table 1710.

The model also includes a policy union table 1730—listing policy unions assigned to the language translation module, a policy union policy table 1732—listing the policies which are joint in each policy union, a technical policy table 1734—listing implementation items and a knowledge module for each policy, a knowledge module table 1736—listing the knowledge modules, and knowledge item table 1738—listing the knowledge items in each knowledge module.

Exemplary Scenario

The following is an exemplary scenario implementing the methods described hereinabove.

The example scenario relates to two technology instances: a Windows™ 2000 Server and an IIS™ 5.0 web server.

First, a first Knowledge Module for Windows™ (KM) is created which includes a certain knowledge item (KI) for a windows W3SVC service. In the KI the windows service is to be configured as active.

Then, a second KM is created for the IIS™, where a matching KI is created for the same W3SVC service (that is to say—having the same where field values). However, according to the matching KI, the W3SVC service is to be configured as disabled.

As the two KIs relate to the same configuration activity (have the same where values), which in this example involve the enablement/disablement of the W3SVC service, a conflict between the two is apparent, since one expects the service to be enabled and one expects it to be disabled. The conflict is added to a potential conflict repository.

A first technical policy is created for Windows™ 2000, based on the first KM, namely the Windows KM. In the Windows™ 2000 technical policy, the KI is not overridden by an inheritance item and thus remains as originally defined for the KM. The first technical policy is assigned a priority: 1 by the user.

A second technical policy is defined for IIS™ 5.0, based on the second KM, having the W3SVC service KI where the windows service is configured as disabled. The second policy has a priority: 10.

SANS™ (System Administration, Auditing, Networking, and Security) institute is a cooperative organization for research, education and standardization in the field of information security.

The present scenario relates to a SANS™ recommended security policy which includes a directive: “Services and applications that will not be used must be disabled where practical”

In the exemplary scenario, a Language Knowledge Module is now created for the “Services and applications that will not be used must be disabled where practical” directive.

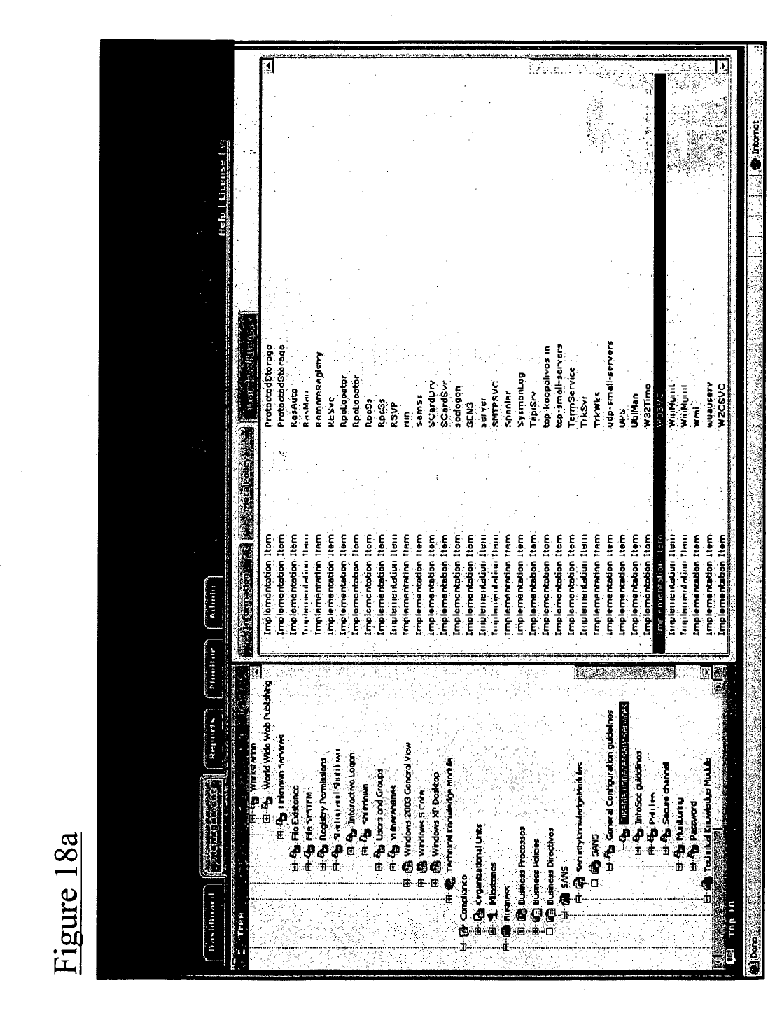

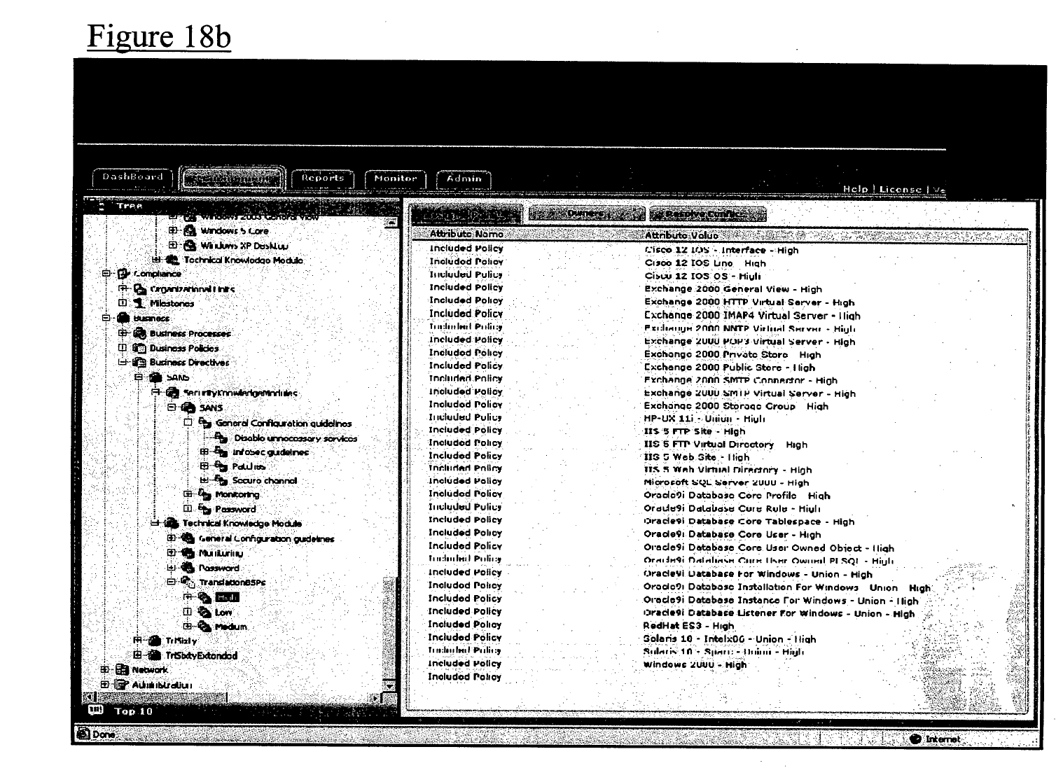

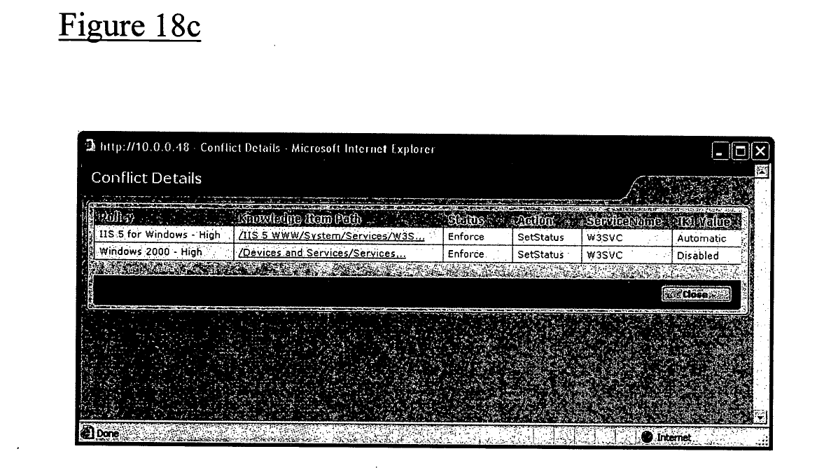

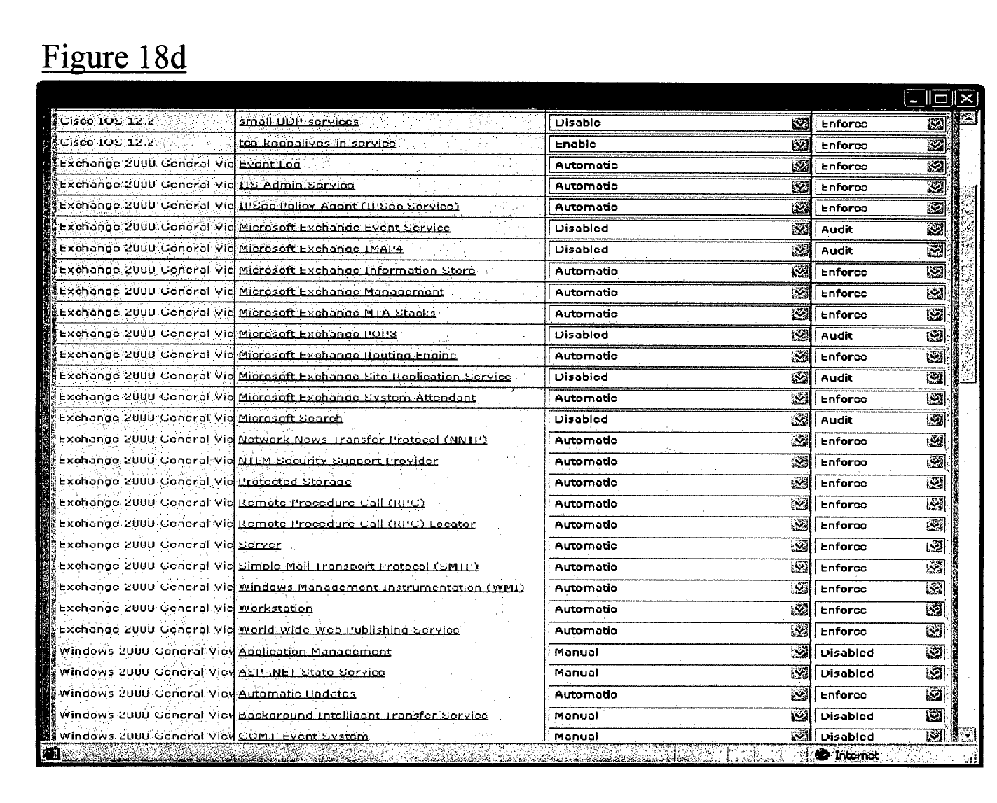

First, all knowledge items that are relevant to the services, and thus to the directive, are mapped to the directive, including the two W3SVC related K's, As illustrated in FIG. 18a.

Then, a Translation Language Module (TLM) is created for the SANS policy, for defining its translation into technical policies.

The TLM is defined with Translation Polices for the Low, Medium, and High levels that each directive may be assigned with.

Each translation policy is assigned technical policies to be used for determining the values for the translation items KIs, The translation items are the knowledge items mapped as translation items for the directives in the Language KM, as shown in the right side of the screen shot presented in FIG. 18b. In the figure, the technical policies are classified as induced policies.

Among the assigned technical policies there are the Windows and IIS technical policies described hereinabove. As a result, a conflict is detected between the two technical polices, as potential conflict defined in the potential conflict repository are set, as shown in FIG. 18c.

The conflict is resolved based on the different priorities of the two technical polices, as described in further detail hereinabove in the conflict detection and resolution methods section.

The user may be presented the list of all mapped KIs for the directive, and the translation results according to the selected level, impact, or criteria as shown in FIG. 18d.

The user may now define a language policy, by selecting a translation policy (in accordance with his preferred security level) for each language directive. Based on the user's selection, the directive is to be translated to IKs describing its technical level implementation, as described in greater detail hereinabove.

It is expected that during the life of this patent many relevant devices and systems will be developed and the scope of the terms herein, particularly of the terms “Server”, “Operating system”, and “Network” is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. Apparatus for computer network management, comprising:
a) a knowledge definer, operable for defining a knowledge module comprised of a plurality of knowledge items, hierarchically arranged according to technologies implemented on the computer network, each of said knowledge items comprising possible values for a configuration activity of one of said technologies; and
b) a policy definer, associated with said knowledge definer, operable for defining at least one technical policy based on said knowledge module, usable for overriding selected values of said possible values while keeping remaining values of said possible values, said technical policy inheriting from said knowledge module.

2. The apparatus of claim 1, further comprising a policy execution manager for managing execution of said technical policy on the computer network.

3. The apparatus of claim 1 further comprising at least one device agent, implemented on a device in the computer network, configured to execute said technical policy on said device.

4. The apparatus of claim 1, further comprising a device repository manager, operable for creating and updating a device repository, said device repository storing information relating to a plurality of devices and technology instances in the computer network.

5. The apparatus of claim 4, wherein said device repository updater is configured to automatically discover a device in said computer network and to automatically update said device repository with information relating to said device.

6. The apparatus of claim 1, wherein said technical policy inherits said knowledge items from said knowledge module.

7. The apparatus of claim 1, wherein said technical policy inherits said hierarchical arrangement from said knowledge module.

8. The apparatus of claim 1, wherein said policy definer is further operable for defining a second technical policy inheriting from a first of said technical policies.

9. The apparatus of claim 1, wherein said policy definer is further operable for defining a joint technical policy inheriting from at least two of said technical policies.

10. The apparatus of claim 1, further comprising a conflict detector, associated with said policy definer, configured to detect a conflict between at least two of said technical policies.

11. The apparatus of claim 10, wherein said conflict involves at least two knowledge items potentially relating to the same instance of technology in the computer network.

12. The apparatus of claim 10, wherein said conflict is a logical conflict involving at least two knowledge items relating to different instances of technology in the computer network.

13. The apparatus of claim 10, wherein said conflict detector is further configured to resolve said conflict.

14. The apparatus of claim 1, further comprising a translation definer, operable for defining a translation between at least one language directive and at least one of said knowledge items.

15. The apparatus of claim 14, wherein said translation definer is operable for defining a translation between two of said language directives.

16. The apparatus of claim 1, further comprising a policy assigner, operable for assigning said technical policy to a respective technology instance in the computer network, for implementing said policy for the technology instance.

17. The apparatus of claim 1, further comprising a graphical user interface (GUI) manager, associated with said knowledge definer and said policy definer, configured to manage an interaction with a user to define said knowledge module, to define said technical policy utilizing a user interface based on said hierarchical arrangement, and to assign said technical policy to a respective technology instance in the computer network, for implementing said policy at said technology instance.

18. The apparatus of claim 1, wherein said configuration activities are security configuration activities.

19. A network configuration control apparatus comprising a configuration controller, operable by a user for customizing a configuration defined by knowledge items, each knowledge item comprising possible values for a configuration activity of a technology in the network.

20. Method for computer network management, comprising:
a) defining at least one knowledge module comprised of a plurality of knowledge items, hierarchically arranged according to technologies implemented in the computer network, each of said knowledge items comprising possible values for a configuration activity of a respective one of said technologies; and
b) defining at least one technical policy based on said knowledge module, usable for overriding selected values of said possible values while keeping remaining values of said possible values, said technical policy inheriting from said knowledge module.

21. The method of claim 20, wherein said technical policy inherits said knowledge items from said knowledge module.

22. The method of claim 20, wherein said technical policy inherits said hierarchical arrangement from said knowledge module.

23. The method of claim 20, further comprising defining a second technical policy inheriting from a first of said technical policies.

24. The method of claim 20, further comprising defining a joint technical policy inheriting from at least two of said technical policies.

25. The method of claim 20, further comprising detecting a conflict between at least two of said technical policies.

26. The method of claim 25, wherein said conflict involves at least two knowledge items potentially relating to the same instance of technology in the computer network.

27. The method of claim 25, wherein said conflict is a logical conflict involving at least two knowledge items relating to different instances of technology in the computer network.

28. The method of claim 20, further comprising resolving a conflict between at least two of said technical policies.

29. The method of claim 20, further comprising defining a translation between at least one language directive and at least one of said knowledge items.

30. The method of claim 29, further comprising defining a translation between two of said language directives.

31. The method of claim 20, further comprising assigning said technical policy to an instance of technology in the computer network, for implementing said policy at said instance of technology.

32. A conflict detection apparatus for detecting conflicts between technical policies in a computer network, comprising:
a conflict detector, configured to detect a conflict between at least two technical policies implemented on the computer network.

33. The apparatus of claim 32, wherein said conflict detector is further configured to resolve said conflict.

34. The apparatus of claim 32, wherein each of said technical policies is based on a plurality of knowledge items hierarchically arranged according to technologies in the computer network, each of said knowledge items comprising possible values for a configuration activity of one of said technologies.

35. Apparatus for computer network management, comprising:
a translation definer, operable for defining a translation between at least one language directive and at least one respective configuration activity.

36. The apparatus of claim 35, wherein said translation definer is further operable for defining a translation between two of said language directives.

37. The apparatus of claim 35, further comprising a translator, operable for translating a language directive to at least one configuration activity of a technology implemented on the computer network, based on said translation.

38. A method for system configuration of a network or elements thereof, comprising:
a) generating database items for each one of a plurality of configurations of said network or network element;
b) forming said database items into a knowledge base of said network; and
c) configuring said network or elements thereof by selecting one of said database items from said knowledge base.

39. The method of claim 38, comprising extending said knowledge base by combining said database items, thereby to permit application of more than one configuration simultaneously.

40. The method of claim 39, wherein said combining said database items comprises resolving conflicts between settings in said database items.

41. The method of claim 40, wherein said resolving conflicts between settings comprises prioritizing one setting over another setting in said conflict.

42. The method of claim 41, wherein said prioritizing is based on a predetermined rule.

43. The method of claim 42, comprising utilizing a high level language including language directives, and assigning said database items and said policies to said directives, thereby to allow a high level user to configure said network or elements therein.

44. The method of claim 38, comprising utilizing a high level language including language directives, and assigning said database items to said directives, thereby to allow a high level user to configure said network or elements therein.
